(19) United States
(12) Patent Application Publication
(10) Pub. No.: US 2023/0119551 A1
(43) Pub. Date: Apr. 20, 2023

(54) MAGNETIC RECORDING MEDIUM

(71) Applicant: Sony Group Corporation, Tokyo (JP)

(72) Inventors: Taikei ENOMOTO, Tokyo (JP); Masaru Jasper TERAKAWA, Tokyo (JP); Minoru YAMAGA, Tokyo (JP)

(21) Appl. No.: 17/914,639

(22) PCT Filed: Jul. 20, 2020
(86) PCT No.: PCT/JP2020/028064

§ 371 Date: Sep. 26, 2022

(30) Foreign Application Priority Data
Mar. 31, 2020 (JP) 2020-062425

(51) Int. Cl. G11B 5/714; G11B 5/706; G11B 15/43; G11B 5/78

(52) U.S. Cl. CPC G11B 5/714; G11B 5/70678; G11B 15/43; G11B 5/78

(57) ABSTRACT

An object is to further improve a thermal stability and an electromagnetic conversion characteristic of a magnetic recording medium.

The present technology provides a magnetic recording medium that includes a layer structure including: a base layer; and a magnetic layer provided on the base layer and including a magnetic powder, in which an average particle volume of the magnetic powder is 2300 nm³ or less, and a magnetic interaction ΔM calculated by the following expression (1) of the magnetic layer is −0.362≤ΔM≤−0.22,

ΔM={Id(H)+2Ir(H)−Ir(∞)}/Ir(∞) (1)

[where, in the expression (1), Id(H) is a remanent magnetization measured by a direct-current demagnetization, Ir(H) is a remanent magnetization measured by an alternating-current demagnetization, and Ir(∞) is a remanent magnetization measured by an applied magnetic field of 6 kOe].

### TECHNICAL FIELD

The present technology relates to a magnetic recording medium.

### BACKGROUND ART

In recent years, an amount of data collected and stored has increased significantly with the development of IoT, big data, and artificial intelligence. A magnetic recording medium is often used as a medium for recording a large amount of data.

Various techniques have been proposed for the magnetic recording medium. For example, as a technique relating to a magnetic powder included in the magnetic recording medium, Patent Literature 1 below discloses a magnetic recording medium having at least a magnetic layer formed by applying, on a non-magnetic supporting body, a magnetic paint containing a ferromagnetic powder and a binder. The magnetic recording medium is characterized by having, in the above magnetic layer, a carboxyl group and at least one or more hydroxyl groups in a molecule, and in that an aromatic compound as a fused ring in a case where the aromatic ring is two or more is contained in an amount of 0.4 [parts by weight] to 10 [parts by weight] with respect to the above ferromagnetic powder 100 [parts by weight].

### CITATION LIST

### Patent Literature

Patent Literature 1: Japanese Unexamined Patent Application Publication No. 2002-373413

### SUMMARY OF THE INVENTION

### Problem to be Solved by the Invention

A main object of the present technology is to provide a magnetic recording medium having a superior thermal stability and an electromagnetic conversion characteristic.

### Means for Solving the Problem

The present technology provides a magnetic recording medium, including a layer structure including:

a base layer; and

a magnetic layer provided on the base layer and including a magnetic powder, in which

an average thickness t_{T} of the magnetic recording medium is 5.4 μm or less,

an average particle volume of the magnetic powder is 2300 nm³ or less, and

a magnetic interaction ΔM calculated by the following expression (1) of the magnetic layer is −0.362≤ΔM≤−0.22,

ΔM={Id(H)+2Ir(H)−Ir(∞)}/Ir(∞) (1)

[in which, in the expression (1), Id(H) is a remanent magnetization measured by a direct-current demagnetization, Ir(H) is a remanent magnetization measured by an alternating-current demagnetization, and Ir(∞) is a remanent magnetization measured by an applied magnetic field of 6 kOe].

The magnetic powder may be subjected to a perpendicular orientation.

The magnetic interaction ΔM calculated by the expression (1) of the magnetic layer may be −0.35≤ΔM.

The magnetic interaction ΔM calculated by the expression (1) of the magnetic layer may be −0.3≤ΔM.

The average particle volume of the magnetic powder may be 1600 nm³ or less.

The average thickness t_{T} of the magnetic recording medium may be 5.3 μm or less.

The average thickness t_{T} of the magnetic recording medium may be 5.2 μm or less.

An average thickness t_{B} of the base layer may be 4.8 μm or less.

An average thickness t_{B} of the base layer may be 4.4 μm or less.

The base layer may include PET (polyethylene terephthalate) or PEN (polyethylene naphthalate).

A saturation magnetization amount Ms in a longitudinal direction of the recording medium may satisfy the following relation:

3.0×10⁻³emu≤Ms.

An average thickness of the magnetic layer may be 80 nm or less.

An average thickness of the magnetic layer may be 70 nm or less.

An average thickness of the magnetic layer may be 60 nm or less.

A squareness ratio in a perpendicular direction of the magnetic recording medium may be 65% or greater.

A squareness ratio in a perpendicular direction of the magnetic recording medium may be 67% or greater.

A squareness ratio in a perpendicular direction of the magnetic recording medium may be 70% or greater.

The magnetic recording medium may have the layer structure that includes the magnetic layer, a foundation layer, and the base layer in this order.

A ratio of (an average thickness of the magnetic layer+an average thickness of the foundation layer)/(an average thickness of the base layer) may be 0.16 or greater.

The magnetic recording medium may have the layer structure that includes the magnetic layer, a foundation layer, the base layer, and a back layer in this order.

A ratio of (an average thickness of the magnetic layer+an average thickness of the foundation layer+an average thickness of the back layer)/(the average thickness of the magnetic recording medium) may be 0.19 or greater.

A thermal stability KᵤV_{act}/k_{B}T of the magnetic recording medium may be 63 or greater.

SNR of the magnetic recording medium may be 0.3 dB or greater.

The magnetic powder may include a hexagonal ferrite.

The present technology provides a tape cartridge including:

the magnetic recording medium that has a tape shape;

a communication section that communicates with a recording reproducing apparatus;

a storage section; and

a control section that stores, in the storage section, information received from the recording reproducing apparatus via the communication section, and reads the information from the storage section and transmits the information to the recording reproducing apparatus via the communication section in response to a request from the recording reproducing apparatus, in which

the information includes adjustment information for adjusting a tension to be applied in a longitudinal direction of the magnetic recording medium.

The average particle volume of the magnetic powder may be 1500 nm³ or less.

The average particle volume of the magnetic powder may be 1400 nm³ or less.

An average thickness t_{B} of the base layer may be 4.2 μm or less.

An average thickness of the magnetic layer may be 50 nm or less.

### BRIEF DESCRIPTION OF THE DRAWINGS

FIG. 1 is a diagram illustrating an example of remanent magnetization curves (a DCD curve and an IRM curve).

FIG. 2 is a diagram illustrating an example of remanent magnetization curves (an Id(H) curve and an Ir(H) curve).

FIG. 3 is a diagram illustrating an example of a remanent magnetization curve (a DCD curve).

FIG. 4 is a diagram illustrating an example of a remanent magnetization curve (an IRM curve).

FIG. 5 is a diagram illustrating an example of remanent magnetization curves (a DCD curve and an IRM curve).

FIG. 6 is a diagram illustrating an example of a magnetic interaction ΔM(H).

FIG. 7 is a cross-sectional diagram illustrating a magnetic recording medium according to an embodiment of the present technology.

FIG. 8A is a schematic diagram illustrating a layout of a data band and a servo band. FIG. 8B is an enlarged diagram illustrating the data band.

FIG. 9 is an example of a TEM photograph of a magnetic layer.

FIG. 10 is a cross-sectional diagram illustrating a configuration of a magnetic particle.

FIG. 11 is a cross-sectional diagram illustrating a configuration of a magnetic particle according to a modification example.

FIG. 12 is a schematic diagram illustrating a recording reproducing apparatus.

FIG. 13 is an exploded perspective diagram illustrating an example of a configuration of a cartridge.

FIG. 14 is a block diagram illustrating an example of a configuration of a cartridge memory.

FIG. 15 is a schematic diagram illustrating a cross-section of a magnetic recording medium according to a modification example.

FIG. 16 is a schematic diagram illustrating a data band and a servo band formed in a magnetic layer.

FIG. 17 is an exploded perspective diagram illustrating an example of a configuration of a modification example of a cartridge.

### MODES FOR CARRYING OUT THE INVENTION

The following describes preferred embodiments of the present technology. It should be noted that the embodiments described below illustrate exemplary embodiments of the present technology, and the scope of the present technology is not limited only to these embodiments.

The present technology will be described in the following order.
1. Description of Present Technology
2. Embodiments (an example of a coating type magnetic recording medium)
   (1) Configuration of Magnetic Recording Medium
   (2) Method of Manufacturing Magnetic Recording Medium
   (3) Recording Reproducing Apparatus
   (4) Cartridge
   (5) Modification Example of Cartridge
   (6) Effect
   (7) Modification Example
3. Examples

### 1. DESCRIPTION OF PRESENT TECHNOLOGY

A magnetic recording medium according to the present technology has a magnetic layer that includes a magnetic powder having a particular particle volume, and a magnetic interaction ΔM in the magnetic layer is within a particular numerical range. Thus, the magnetic recording medium of the present technology is excellent in thermal stability and also in electromagnetic conversion characteristic. The magnetic interaction ΔM, a thermal stability KᵤV_{act}/k_{B}T, and an electromagnetic conversion characteristic SNR are described in more detail below.

A higher recording density is required for a magnetic recording medium. In order to achieve a higher recording density and further improve the electromagnetic conversion characteristic, it is considered to improve a filling rate of the magnetic powder in the magnetic layer by miniaturizing the magnetic powder.

However, when the magnetic powder is miniaturized, the magnetic powder is agglomerated to establish a state as if coarse particles are present in the magnetic layer, which increases a noise and lowers SNR. Accordingly, it is requested to improve a dispersion property of the magnetic powder.

In addition, due to the miniaturization of the magnetic powder, the smaller particle volume of the magnetic powder makes a magnetization recorded in the magnetic recording medium (specifically, a magnetic layer) liable to be lost by a thermal energy, which may lead to an attenuation of a data signal. Thus, as the particle volume of the magnetic powder included in the magnetic recording medium becomes smaller, a stability of the magnetic recording medium to heat (also referred to as a thermal stability) may decrease and a preservation stability of the magnetic recording medium may decrease. Therefore, from a viewpoint of the thermal stability, it is important that particles of the magnetic powder are moderately aggregated. Accordingly, a decrease in the particle volume of the magnetic powder may result in an increase in the recording density and an increase in the electromagnetic conversion characteristic, but may also result in a decrease in the thermal stability.

It is possible to represent a parameter relating to an aggregation state of the magnetic powder in the magnetic layer of the magnetic recording medium by the magnetic interaction ΔM represented by the following expression (1).

ΔM={Id(H)+2Ir(H)−Ir(∞)}/Ir(28) (1)

In this expression (1), Id(H) is a remanent magnetization measured by a direct-current demagnetization, Ir(H) is a remanent magnetization measured by an alternating-current demagnetization, and Ir(∞) is a remanent magnetization measured by an applied magnetic field of 6 kOe.

In the magnetic recording medium of the present technology, the magnetic interaction ΔM is −0.362≤ΔM≤−0.22. From a viewpoint of improving the thermal stability, the magnetic interaction ΔM may be preferably ΔM≤−0.225, more preferably ΔM≤−0.23, still more preferably ΔM≤−0.235, and still more preferably ΔM≤−0.27. In addition, from a viewpoint of improving the electromagnetic conversion characteristic, the magnetic interaction ΔM may be preferably −0.35<ΔM, more preferably −0.3<ΔM, and still more preferably −0.28<ΔM. In other words, the magnetic interaction ΔM may be preferably −0.35<ΔM≤−0.225, more preferably −0.3≤ΔM≤−0.23, and still more preferably −0.28≤ΔM≤−0.235. In the magnetic recording medium of the present technology, both the thermal stability and the electromagnetic conversion characteristic are improved because the magnetic interaction ΔM is within the above numerical range. Note that in a case where the magnetic interaction ΔM is too small (e.g., less than −0.362), it is possible to improve the thermal stability, but the electromagnetic conversion characteristic may be deteriorated. In a case where the magnetic interaction ΔM is too large (e.g., greater than −0.22), it is possible to improve the electromagnetic conversion characteristic, but thermal stability may be deteriorated.

The magnetic interaction ΔM is a parameter that indicates an aggregation state of the magnetic power particles. The magnetic interaction ΔM will be described below with reference to the drawings.

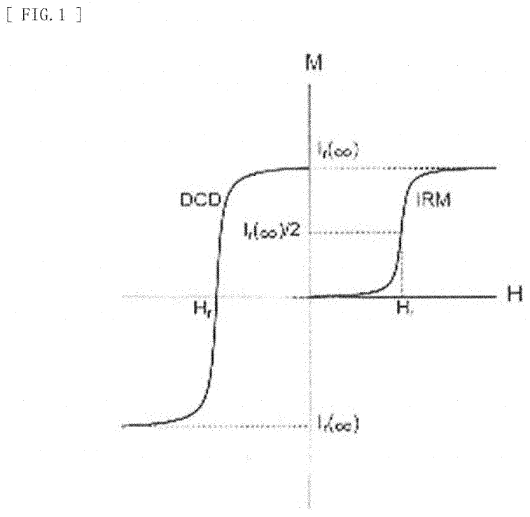

In the absence of an interaction between the magnetic power particles, Id(H) is measured as a remanent magnetization curve (a DCD curve: DC demagnetization remanence curve) obtained as a value of a remanent magnetic field with respect to a negative applied magnetic field, by returning a magnetic field to zero after saturating a magnetization of a sample in one direction by a sufficiently strong applied magnetic field, as illustrated in FIG. 1. Further, as illustrated in FIG. 1, Ir(H) is measured as a remanent magnetization curve (an IRM curve: Isothermal Remanent Magnetization) obtained as a value of a remanent magnetization with respect to a positive applied magnetic field from a state in which a demagnetization is performed to make a magnetization distribution of a sample isotropic.

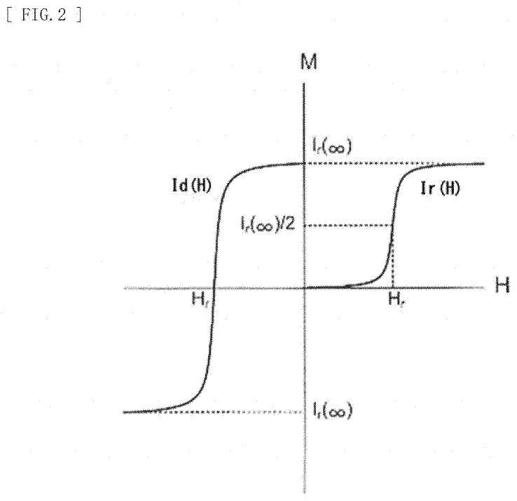

As illustrated in FIG. 2, in an Id(H) curve (in other words, the DCD curve), a value of Id(H) at H=0 (Id(0)) is equal to a value when the magnetization of the sample is sufficiently saturated, and this value represents the same value as Ir(∞). The Id(H) curve (the DCD curve) decreases gradually with an increase in the negative applied magnetic field, and becomes Id(H)=0 when the entire half magnetic field is reversed. A value of H at this time is denoted by Hr. Further, when a magnetic field is applied, Id(∞)=Ir(∞) is finally obtained.

As illustrated in FIG. 2, in an Ir(H) curve (in other words, the IRM curve), the initial state is demagnetized isotropically. A magnetization amount reversed by the application of the magnetic field is half of the number of particles (the magnetization amount) of the magnetic powder as a whole. With the application of a positive magnetic field, an Ir(H) value (an IRM value) gradually increases, and when Hr is reached, the Ir(H) value (the IRM value) of a medium in which an inter-magnetic-powder-particle interaction is not present becomes half the Ir(∞) value. Further, when a magnetic field is applied, the Ir(∞) value is finally obtained.

A relationship between Id(H) and Ir(H) in a case where the inter-magnetic-powder-particle interaction does not exist is as follows.

Id(H)=Ir(∞)−2Ir(H)

The following term is used, whereby the following is satisfied.

2Ir(H)=Ir(∞)−Id(H)

The right side of the above expression corresponds to the reversed magnetization amount in the DCD curve. When both sides of the above expression are normalized, the following expression (2) is satisfied.

Md(H)=1−2Mr(H) (2)

Where, at the time of measurement, the correction is performed as Md(H)=Id(H)/Id(0), Mr(H)={Ir(H)−Ir(0)}/{Ir(∞)−Ir(0)}. This is because Ir(∞)≈Id(0) holds true but they are not perfectly matched. Further, this is because Ir(0) is not completely demagnetized and does not become zero.

The above expression (2) is an expression applicable to an aggregate of uniaxial single-domain fine particles in which no inter-magnetic-powder-particle interaction exists, and does not depend on a magnetization reversal mechanism within the particles or a particle orientation. That is, in a case where the inter-magnetic-powder-particle interaction exists, the above expression (2) does not apply, and equal sign of the right side and the left side does not hold. Therefore, quantitative handling of the inter-magnetic-powder-particle interaction was examined by ΔM(H) represented by the expression (3) below.

ΔM(H)=Md(H)−{1−2Mr(H)} (3)

Where Md(H)=Id(H)/Id(0), Mr(H)={Ir(H)−Ir(0)}/{Ir(∞)−Ir(0)}.

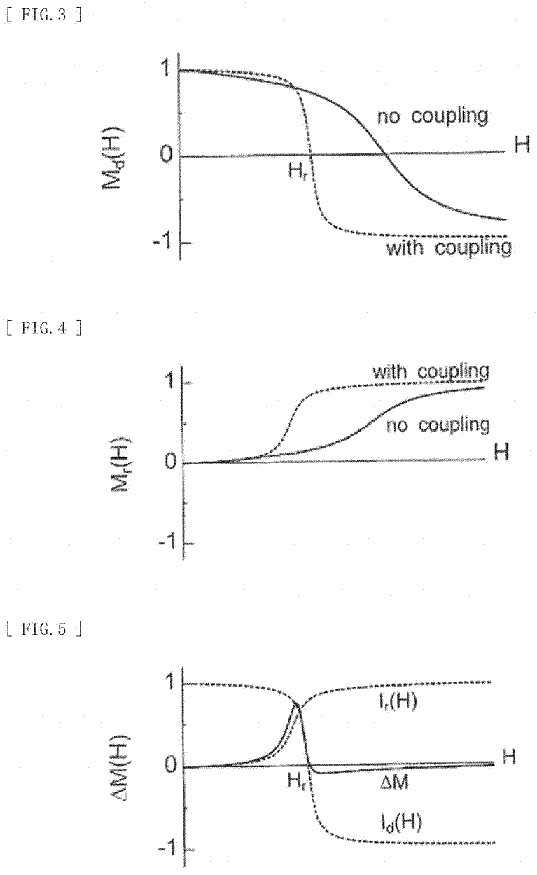

In the presence of the inter-magnetic-powder-particle interaction, a direction of the magnetization is substantially aligned in a state of Md(0), so that a field directed in the same direction as the magnetization acts inside a coating film to which the magnetic powder is applied. Therefore, a change in Md(H) is small until H reaches a certain degree of level. As illustrated in FIG. 3, a value of Md (H) changes rapidly to negative due to a rapid progress of a magnetization reversal resulting from a Vortex (a vortex structure of a magnetic moment) generation and a Vortex motion as H approaches Hr.

On the other hand, because an IRM (in other words, Ir(H)) measurement is started from a demagnetization state, a coating film has been filled with a large number of Vortex prior to the application of magnetic field. Therefore, as illustrated in FIG. 4, when H is increased, the rapid magnetization reversal resulting from the Vortex motion progresses from a region where H is small as compared with a case of the DCD measurement of FIG. 3 described previously.

When the above expression (3) is applied and examined, because an increase amount of Mr(H) becomes larger than a decrease amount of Md(H), a value of ΔM(H) becomes positive consequently. As illustrated in FIG. 5, the abrupt magnetization reversal progresses easily (a change starting point of Mr (H) is early) means that an interaction between magnetic power particles is considered to be strong, and ΔM is turned positively as described above represents that the interaction between magnetic power particles is large.

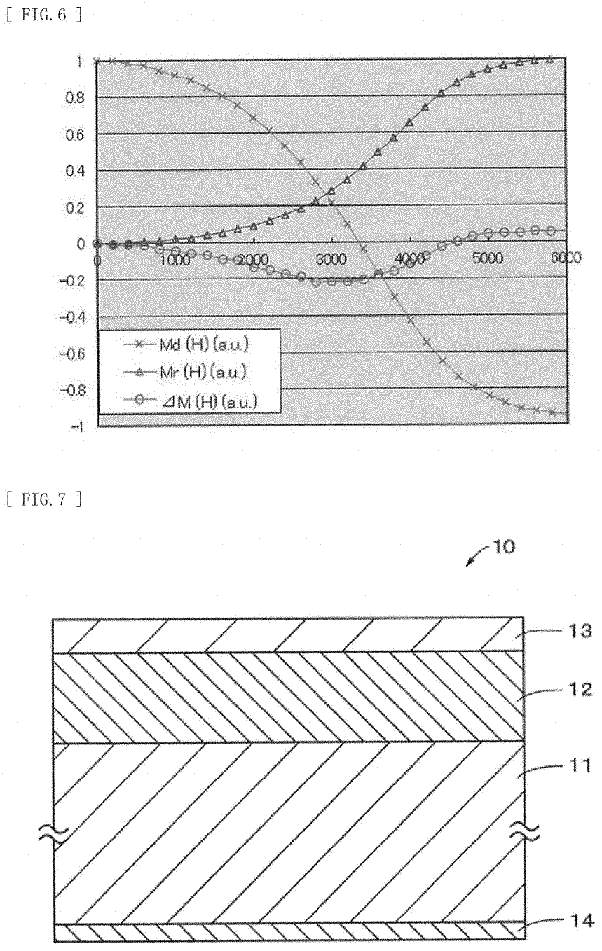

In the present technology, Ir(H) in the above expression (3) is measured for each 200 Oe at H in a range from 0 to 6 kOe. In addition, Id(H) is measured for each 200 Oe at H in a range from 0 to −6 kOe. As illustrated in FIG. 6, a smallest value of ΔM(H) calculated from each measured Ir(H) value and each Id(H) value was set as an index ΔM indicating a strength of the interaction between the magnetic power particles.

In other words, in the present technology, when ΔM is included within the above numerical range, it is possible to improve the thermal stability of the magnetic recording medium and further to improve the electromagnetic conversion characteristic.

In the magnetic recording medium of the present technology, from a viewpoint of securing good SNR and suppressing generation of a noise, a saturation magnetization amount Ms of the magnetic recording medium in a longitudinal direction may be preferably 3.0×10⁻³emu≤Ms, more preferably 3.2×10⁻³emu≤Ms, and even more preferably 3.4×10⁻³emu≤Ms.

It is possible to determine the saturation magnetization amount Ms as follows. First, an M-H hysteretic loop of the magnetic recording medium is obtained using VSM. Next, the saturation magnetization amount Ms is obtained from the obtained M-H hysteresis loop.

The decrease in the thermal stability due to the reduction in the particle volume resulting from the miniaturization of the magnetic powder described above will be described below. It is possible to represent a relationship between the thermal stability and a coercivity of the magnetic recording medium by Bean's equation represented below.

Bean's equation

H_{c}=(2Kᵤ/M)(1−5k_{B}T/KᵤV_{act})^{0.5} [Expression 1]

In this equation, V_{act}=an activation volume of the magnetic powder included in the magnetic recording medium, H_{c}=a coercivity, Kᵤ=a crystal magnetic anisotropy, M=a magnetization amount, k_{B}=a Boltzmann constant, and T=a temperature.

KᵤV_{act}/k_{B}T configured by the parameters included in this equation is known as an index value of the thermal stability, and the higher this value, the higher the thermal stability. As can be seen from the thermal stability KᵤV_{act}/k_{B}T, miniaturizing the magnetic powder, i.e., reducing the particle volume of the magnetic powder, results in the decrease in the thermal stability. The decrease in the thermal stability leads to a decrease in a preservation stability of the magnetic recording medium, which is particularly problematic in a case where the magnetic recording medium is to be stored for a long period of time.

The thermal stability KᵤV_{act}/k_{B}T of the magnetic recording medium according to the present technology may be preferably 63 or greater, more preferably 65 or greater, still more preferably 70 or greater, and still more preferably 80 or greater. The magnetic recording medium according to the present technology is excellent in the thermal stability due to its thermal stability KᵤV_{act}/k_{B}T being within an above numerical range, which allows for the excellent preservation stability and also allows for an excellent stability in long-term storage. Furthermore, the magnetic recording medium is also superior from a viewpoint of an output signal.

The magnetic recording medium according to the present technology may preferably have the SNR of 0.3 dB or greater, more preferably 0.5 dB or greater. In the magnetic recording medium according to the present technology, the SNR is within the above numerical range, allowing for a good electromagnetic conversion characteristic.

The average particle volume of the magnetic powder included in the magnetic recording medium according to the present technology is 2300 nm³ or less, preferably 2000 nm³ or less, more preferably 1600 nm³ or less, more desirably 1500 nm³ or less, still more desirably 1400 nm³ or less, and still more preferably 1300 m³ or less. By allowing the average particle volume to be within a numerical range described above, the electromagnetic conversion characteristic is improved. The magnetic recording medium according to the present technology is excellent in the thermal stability as described above, even though the average particle volume of the magnetic powder included in the magnetic recording medium according to the present technology is extremely small. Although it is difficult to achieve both the electromagnetic conversion characteristic and the thermal stability, the present technology makes it possible to improve both the electromagnetic conversion characteristic and the thermal stability. In particular, by allowing ΔM to be within the numerical range described above, the electromagnetic conversion characteristic and the thermal stability of the magnetic recording medium are excellent even when the average particle volume of the magnetic powder is small as described above.

The average particle volume of the magnetic powder may be, for example, 500 nm³ or greater, in particular, 700 nm³ or greater.

In the present technology, a squareness ratio in a perpendicular direction may be preferably 65% or greater, more preferably 67% or greater, and still more preferably 70% or greater. By allowing the squareness ratio to be within a numerical range described above, a perpendicular orientation property of the magnetic powder becomes sufficiently high, making it possible to achieve better cNR. Therefore, it is possible to achieve a better electromagnetic conversion characteristic.

In the present technology, a squareness ratio in a longitudinal direction may be preferably 35% or less, more preferably 27% or less, and still more preferably 20% or less. By allowing the squareness ratio to be within the numerical range described above, a perpendicular orientation property of the magnetic powder becomes sufficiently high, making it possible to achieve better SNR. Therefore, it is possible to achieve a better electromagnetic conversion characteristic.

An average thickness t_{T} of the magnetic recording medium according to the present technology may be preferably 5.8 μm or less, more preferably 5.6 μm or less, more preferably 5.5 μm or less, even more preferably 5.4 μm or less, even more preferably 5.3 μm or less, even more preferably 5.2 μm or less, even more preferably 5.1 μm or less, and even more preferably 5.0 μm or less. The magnetic recording medium according to the present technology may thus be thin in a total thickness. This reduction in the total thickness of the magnetic recording medium according to the present technology makes it possible, for example, to increase a length of a tape to be wound in one magnetic recording cartridge, thereby increasing a recording capacity per magnetic recording cartridge. That is, in addition to the improvement in the electromagnetic conversion characteristic and the thermal stability, it is possible for the present technology to improve the recording capacity as well. A lower limit value of the average thickness t_{T} of the magnetic recording medium 10 is not particularly limited, but is, for example, 3.5μm≤t_{T}.

A width of the magnetic recording medium according to the present technology may be, for example, from 5 mm to 30 mm, particularly from 7 mm to 26 mm, more particularly from 10 mm to 20 mm, and even more particularly from 11 mm to 19 mm. A length of the tape-shaped magnetic recording medium according to the present technology may be, for example, from 500 m to 1500 m. For example, the tape width according to the LTO8 standard is 12.65 mm and the length is 960 m.

The magnetic recording medium according to the present technology has a tape shape and may be, for example, an elongated magnetic recording tape. The tape-shaped magnetic recording medium according to the present technology may be contained, for example, in a magnetic recording cartridge. More specifically, the tape-shaped magnetic recording medium according to the present technology may be wound around a reel in the magnetic recording cartridge and contained in the cartridge.

In one preferred embodiment of the present technology, the magnetic recording medium according to the present technology may include a magnetic layer, a foundation layer, a base layer (may also be referred to as a base), and a back layer. These four layers may be stacked in this order. The magnetic recording medium according to the present technology may include another layer in addition to these layers. The other layer may be selected on an as-necessary basis depending on a type of the magnetic recording medium. The magnetic recording medium according to the present technology may be, for example, a magnetic recording medium of a coating type. The magnetic recording medium of the coating type will be described in more detail below in 2.

### 2. EMBODIMENTS OF PRESENT TECHNOLOGY (AN EXAMPLE OF A COATING TYPE MAGNETIC RECORDING MEDIUM)

(1) Configuration of Magnetic Recording Medium

First, referring to FIG. 7, a configuration of the magnetic recording medium 10 according to an embodiment will be described. The magnetic recording medium 10 includes an elongated base layer 11, a foundation layer 12 provided on one principal face of the base layer 11, a magnetic layer 13 provided on the foundation layer 12, and a back layer 14 provided on the other principal face of the base layer 11. Note that the foundation layer 12 and the back layer 14 are provided on an as-necessary basis and may not be provided.

The magnetic recording medium 10 has an elongated tape-like shape and travels in a longitudinal direction upon recording and reproducing. A surface of the magnetic layer 13 serves as a surface on which a magnetic head travels. The magnetic recording medium 10 is preferably used in a recording reproducing apparatus that includes a ring-shaped head as a recording head. Note that, in this specification, the term “perpendicular direction” means a direction perpendicular to a surface of the magnetic recording medium 10 (a thickness direction of the magnetic recording medium 10), and the term “longitudinal direction” means a longitudinal direction (a traveling direction) of the magnetic recording medium 10.

(Base Layer)

The base layer 11 is a non-magnetic supporting body that supports the foundation layer 12 and the magnetic layer 13. The base layer 11 has an elongated film-like shape. An average thickness of the base layer 11 may be preferably 4.8 μm or less, more preferably 4.6 μm or less, more preferably 4.5 μm or less, more preferably 4.4 μm or less, still more preferably 4.2 μm or less, and still more preferably 4.0 μm or less. If the average thickness of the base layer 11 is 4.8 μm or less, it is possible to increase the recording capacity that allows for recording in one data cartridge as compared with a typical magnetic recording medium. The average thickness of the base layer 11 may be preferably 3 μm or greater, more preferably 3.3 μm or greater, and still more preferably 3.5 μm or greater. If the average thickness of the base layer 11 is 3μm or greater, it is possible to suppress a decrease in strength of the base layer 11.

The average thickness of the base layer 11 is determined as follows. First, the magnetic recording medium 10 having a width of ½ inch is prepared and the magnetic recording medium 10 is cut into a length of 250 mm to fabricate a sample. Subsequently, layers other than the base layer 11 of the sample (i.e., the foundation layer 12, the magnetic layer 13, and the back layer 14) are removed with a solvent such as MEK (methyl ethyl ketone) or dilute hydrochloric acid. Next, using a laser hologage (LGH-110C) manufactured by Mitutoyo Corporation as a measurement apparatus, a thickness of the sample (the base layer 11) is measured at positions of five or more, and measurement values at those positions are simply averaged (an arithmetic average) to calculate the average thickness of the base layer 11. Note that the measurement positions are randomly selected from the sample.

The base layer 11 includes, for example, at least one of polyesters, polyolefins, cellulose derivatives, vinyl-based resins, or other polymeric resins. In a case where the base layer 11 includes two or more of the above materials, the two or more of them may be mixed, copolymerized, or laminated.

The polyesters include, for example, at least one of PET (polyethylene terephthalate), PEN (polyethylene naphthalate), PBT (polybutylene terephthalate), PBN (polybutylene naphthalate), PCT (polycyclohexylenedimethylene terephthalate), PEB (polyethylene-p-oxybenzoate), or polyethylene bisphenoxycarboxylate.

The polyolefins include, for example, at least one of PE (polyethylene) or PP (polypropylene). The cellulose derivatives include, for example, at least one of cellulose diacetate, cellulose triacetate, CAB (cellulose acetate butyrate), or CAP (cellulose acetate propionate). The vinyl-based resins include, for example, at least one of PVC (polyvinyl chloride) or PVDC (polyvinylidene chloride).

Other polymeric resins include, for example, at least one of PA (polyamide, nylon), aromatic PA (aromatic polyamide, aramid), PI (polyimide), aromatic PI (aromatic polyimide), PAI (polyamideimide), aromatic PAI (aromatic polyamideimide), PBO (polybenzoxazole, for example, Zylon (Registered Trademark)), polyether, PEK (polyether ketone), PEEK (polyether ether ketone), polyetherester, PES (polyether sulfone), PEI (polyetherimide), PSF (polysulfone), PPS (polyphenylene sulfide), PC (polycarbonate), PAR (polyarylate), or PU (polyurethane).

The base layer 11 includes, for example, polyester as a main component. The polyester may be, for example, a mixture of one or two or more of PET (polyethylene terephthalate), PEN (polyethylene naphthalate), PBT (polybutylene terephthalate), PBN (polybutylene naphthalate), PCT (polycyclohexylenedimethylene terephthalate), PEB (polyethylene-p-oxybenzoate), and polyethylene bisphenoxycarboxylate. In this specification, the term “main component” means that the component is a component having a highest content rate among the components structuring the base layer. For example, the main component of the base layer 11 is the polyester may mean that the content rate of the polyester in the base layer 11 is, for example, 50% by mass or greater, 60% by mass or greater, 70% by mass or greater, 80% by mass or greater, 90% by mass or greater, 95% by mass or greater, or 98% by mass or greater, with respect to the mass of the base layer 11, or may mean that the base layer 11 includes the polyester solely. In the present technology, the base layer 11 may be preferably formed by PET (polyethylene terephthalate) or PEN (polyethylene naphthalate).

In this embodiment, the base layer 11 may include, in addition to the polyester, a resin other than the polyester described below.

According to a preferred embodiment of the present technology, the base layer 11 may be formed by PET or PEN.

(Magnetic Layer)

The magnetic layer 13 is a recording layer for recording a signal. The magnetic layer 13 includes, for example, a magnetic powder and a binder. The magnetic layer 13 may further include, on an as-necessary basis, at least one of additives such as a lubricant, an antistatic agent, an abrasive, a hardener, an antirust agent, or a non-magnetic reinforcing particle.

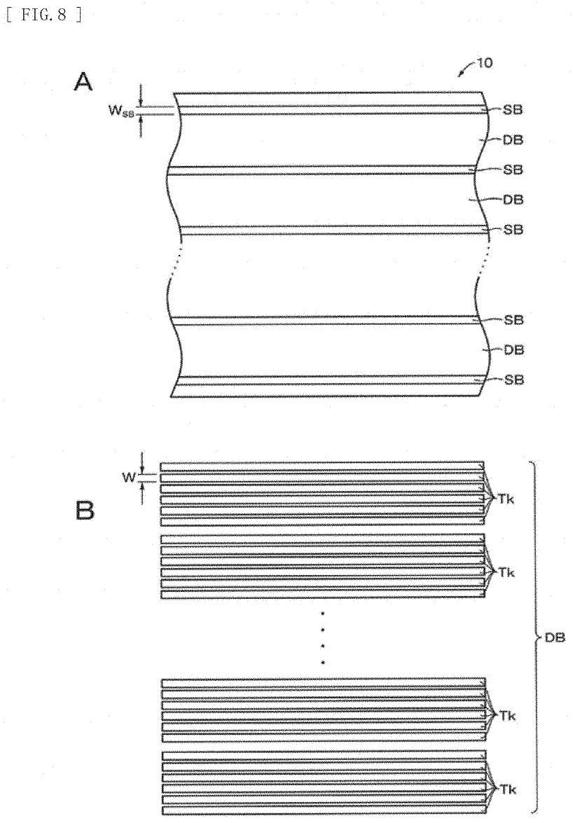

As illustrated in FIG. 8A, the magnetic layer 13 preferably has in advance a plurality of servo bands SB and a plurality of data bands DB. The plurality of servo bands SB is provided at equal intervals in a width direction of the magnetic recording medium 10. The data band DB is provided between the adjacent servo bands SB. A servo signal for controlling magnetic head tracking has been written in advance in the servo band SB. A user data is recorded in the data band DB.

The rate RS of a total area S_{SB} of the servo band SB to an area S of a surface of the magnetic layer 13 (=(S_{SB}/S)×100) may be preferably 4.0% or less, more preferably 3.0% or less, and still more preferably 2.0% or less, from a viewpoint of securing a high recording capacity. On the other hand, a rate R_{S} of the total area S_{SB} of the servo band SB to the area S of the surface of the magnetic layer 13 may preferably be 0.8% or greater, from a viewpoint of securing five or more servo tracks.

The ratio R_{S} of the total area S_{SB} of the servo band SB to the area S of the surface as a whole of the magnetic layer 13 is determined as follows. For example, the magnetic recording medium 10 is developed using a ferricolloid developer (Sigmarker Q manufactured by Sigma Hi-Chemical. Inc.), and then the developed magnetic recording medium 10 is observed by an optical microscope to measure the servo band width W_{SB} and the number of servo bands SB. Next, the rate Rs is calculated from the following expression.

Rate R_{S} [%]=(((servo band width W_{SB})×(the number of servo bands)/(width of magnetic recording medium 10))×100

The number of servo bands SB may be preferably 5 or greater, more preferably 5+4n (where n is a positive integer) or greater, and even more preferably 9+4n or greater. If the number of servo bands SB is 5 or greater, it is possible to suppress an influence on the servo signal due to a dimensional change in the width direction of the magnetic recording medium 10 and to secure stable recording/reproducing characteristics with less off-track. The number of servo bands SB is not particularly limited, but is, for example, 33 or less.

It is possible to confirm the number of servo bands SB as follows. First, a surface of the magnetic layer 13 is observed by a magnetic force microscope (MFM) to obtain an MFM image. Next, the MFM image is used to count the number of servo bands SB.

The servo band width W_{SB} may be preferably 95 μm or less, more preferably 60 μm or less, and still more preferably 30 μm or less, from a viewpoint of securing the high recording capacity. The servo band width WSB may be preferably 10 μm or greater. A manufacturing of a recording head configured to read the servo signal with the servo band width W_{SB} of less than 10 μm may involve difficulties.

It is possible to determine a width of the servo band width W_{SB} as follows. First, a surface of the magnetic layer 13 is observed by the magnetic force microscope (MFM) to obtain an MFM image. Next, the MFM image is used to measure the width of the servo band width W_{SB}.

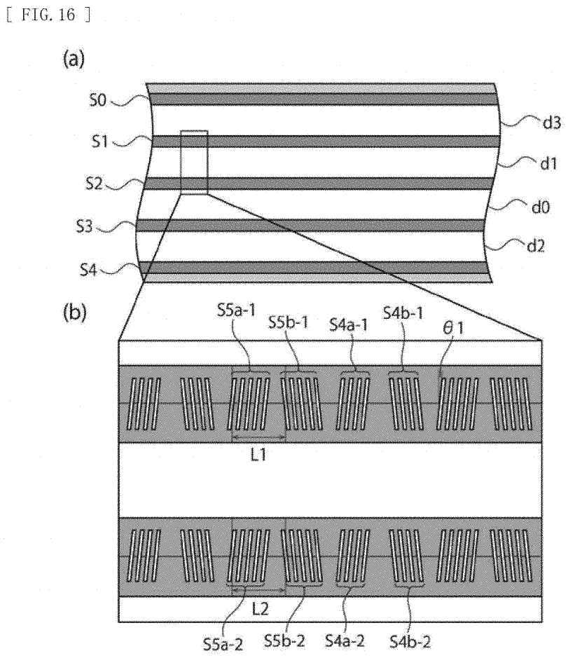

(a) of FIG. 16 is a schematic diagram of the data bands and the servo bands formed in the magnetic layer of the magnetic recording tape. As illustrated in (a) of FIG. 16, the magnetic layer has four data bands d0 to d3. The magnetic layer has a total of five servo bands S0 to S4 in such a manner as to interpose each data band between two servo bands. As illustrated in (b) of FIG. 16, each servo band repeatedly has a frame unit including five servo signals S5a inclined at a predetermined angle θ1, five servo signals S5b inclined at the same angle in the opposite direction to the signals, four servo signals S4a inclined at the predetermined angle θ1, and four servo signals S4b inclined at the same angle in the opposite direction to the signals. The angle θ1 may be, for example, from 5° to 25°, in particular, from 11° to 20°.

The magnetic layer 13 is configured to form a plurality of data tracks Tk in the data band DB, as illustrated in FIG. 8B. A data track width W may be preferably 2.0 μm or less, more preferably 1.5 μm or less, and still more preferably 1.0 μm or less from a viewpoint of securing the high recording capacity. The data track width W may be preferably 0.02 μm or greater.

The data track width W is determined as follows. For example, a data recording pattern of a data band section of the magnetic layer 13 in which data is recorded on the entire surface is observed using a magnetic force microscope (Magnetic Force Microscope: MFM) to obtain an MFM image. The Dimension3100 manufactured by Digital Instruments Corporation and its analysis software are used as the MFM. A measurement region of the MFM image is 10 μm×10 μm, and the 10 μm×10 μm measurement region is divided into 512×512 (=262,144) measuring points. A measurement based on the MFM is performed on three 10 μm×10 μm measurement regions at different locations, i.e., three MFM images are obtained. From the three MFM images obtained, a track width is measured at 10 points using analysis software attached to the Dimension3100, and an average value thereof (which is a simple average), is taken. The average value is the data track width W. Note that a measurement condition of the MFM includes a sweep speed: 1 Hz, a used chip: MFMR-20, a lift height: 20 nm, and a correction: Flatten order 3.

The magnetic layer 13 is configured to record data in such a manner as to allow a minimum value L of an inter-magnetization reversal distance and the data track width W to be preferably W/L≤200, more preferably W/L≤60, still more preferably W/L≤45, and particularly preferably W/L≤30. If the minimum value L of the inter-magnetization reversal distance is constant and the minimum value L of the inter-magnetization reversal distance and the track width W are W/L>200 (i.e., if the track width W is large), the track recording density do not increase, and thus the recording capacity may not be sufficiently secured. Further, if the track width W is constant and the minimum value L of the inter-magnetization reversal distance and the track width W are W/L>200 (i.e., the minimum value L of the inter-magnetization reversal distance is small), a bit length becomes small and a linear recording density is increased, but the SNR may be remarkably deteriorated due to an influence of a spacing loss. Accordingly, in order to suppress the deterioration of the SNR while securing the recording capacity, it is preferable that W/L be in a range of W/L≤60 as described above. However, W/L is not limited to the above ranges, and may be W/L≤23 or W/L≤13. A lower limit value of W/L is not particularly limited, but, for example, 1≤W/L.

From a viewpoint of securing the high recording capacity, the magnetic layer 13 is configured to record data in such a manner as to allow the minimum value L of the inter-magnetization reversal distance to be preferably 55 nm or less, more preferably 53 nm or less, still more preferably 52 nm or less, 50 nm or less, 48 nm or less, or 44 nm or less, particularly preferably 40 nm or less. A lower limit value of the minimum value L of the inter-magnetization reversal distance may preferably be 20 nm or greater in view of a magnetic particle size. The minimum value L of the inter-magnetization reversal distance is taken into account by the magnetic particle size.

The minimum value L of the inter-magnetization reversal distance is determined as follows. For example, a data recording pattern of a data band section of the magnetic layer 13 in which data is recorded on the entire surface is observed using the magnetic force microscope (Magnetic Force Microscope: MFM) to obtain an MFM image. The Dimension3100 manufactured by Digital Instruments Corporation and its analysis software are used as the MFM. A measurement region of the MFM image is 2 μm×2 μm, and the 2 μm×2 μm measurement region is divided into 512×512 (=262,144) measuring points. A measurement based on the MFM is performed on three 2 μm×2 μm measurement regions at different locations, i.e., three MFM images are obtained. 50 bit-to-bit distances are measured from a two-dimensional irregular chart of the recording pattern of the obtained MFM image. A measurement of the bit-to-bit distance is performed using analysis software attached to the Dimension3100. A value that is approximately the largest common divisor of the measured 50 bit-to-bit distances is the minimum value L of the inter-magnetization reversal distance. Note that a measurement condition includes a sweep speed: 1 Hz, a used chip: MFMR-20, a lift height: 20 nm, and a correction: Flatten order 3.

An average thickness tm of the magnetic layer 13 may be preferably 80 nm or less, more preferably 70 nm or less, still more preferably 60 nm or less, and even more preferably 50 nm or less. If the average thickness of the magnetic layer 13 is 80 nm or less, it is possible to uniformly record the magnetization in a thickness direction of the magnetic layer 13 in a case where a ring-type head is used as a recording head, and thereby to improve the electromagnetic conversion characteristic (e.g., SNR). The average thickness tm of the magnetic layer 13 may be preferably 30 nm or greater, more preferably 35 nm or greater, and even more preferably 40 nm or greater. If the average thickness of the magnetic layer 13 is 30 nm or greater, it is possible to secure an output in a case where an MR-type head is used as a reproducing head, and thereby to improve the electromagnetic conversion characteristic (e.g., SNR).

A numerical range of the average thickness of the magnetic layer 13 may be defined by any of the upper limit values described above and any of the lower limit values described above, and may be preferably 30 nm≤tₘ<80 nm, more preferably 35 nm<tₘ≤70 nm, and still more preferably 40 nm≤tₘ60 nm.

The average thickness of the magnetic layer 13 is determined, for example, as follows.

The magnetic recording medium 10 is processed by a FIB (Focused Ion Beam) method or the like to be thin-sectioned. In a case of using the FIB method, a carbon film and a tungsten thin film are formed as protective films as a pretreatment for observing a TEM image of a cross section described later. The carbon film is formed by an evaporation method on a magnetic-layer-side surface and a back-layer-side surface of the magnetic recording medium 10, and the tungsten film is further formed on the magnetic-layer-side surface by the evaporation method or a sputtering method. The thin-sectioning takes place in a length direction (a longitudinal direction) of the magnetic recording medium 10. That is, the thin-sectioning forms a cross-section that is parallel to both the longitudinal direction and the thickness direction of the magnetic recording medium 10.

The cross-section of the thus-obtained thin-sectioned sample is observed by a transmission electron microscope (Transmission Electron Microscope: TEM) under the following condition to obtain a TEM image. Note that a magnification and an accelerating voltage may be adjusted on an as-necessary basis depending on a type of an apparatus.
Apparatus: TEM (H9000NAR manufactured by Hitachi, Ltd.)
Accelerating voltage: 300 kV
Magnification: 100,000 times

Next, the thus-obtained TEM image is used to measure a thickness of the magnetic layer 13 at positions of at least 10 points in the longitudinal direction of the magnetic recording medium 10. Obtained measurement values are simply averaged (an arithmetic average), and the obtained average value is taken as the average thickness [nm] of the magnetic layer 13. Note that the positions at which the measurement is performed are randomly selected from a test piece.

(Magnetic Powder)

Examples of the magnetic particle forming the magnetic powder included in the magnetic layer 13 include, but are not limited to, hexagonal ferrite, epsilon-type iron oxide (c iron oxide), Co-containing spinel ferrite, gamma hematite, magnetite, chromium dioxide, cobalt-deposited iron oxide, and metal (metal). The magnetic powder may be one of these, or may be a combination of two or more. Preferably, the magnetic powder may include the hexagonal ferrite, the c iron oxide, or the Co-containing spinel ferrite. Particularly preferably, the magnetic powder is the hexagonal ferrite. The hexagonal ferrite may particularly preferably include at least one of Ba or Sr. The c iron oxide may particularly preferably include at least one of Al or Ga. These magnetic particles may be selected on an as-necessary basis by a person skilled in the art on the basis of a factor such as a manufacturing process of the magnetic layer 13, the standard of the tape, and a function of the tape, for example.

A shape of the magnetic particle depends on a crystal structure of the magnetic particle. For example, a barium ferrite (BaFe) and a strontium ferrite may have a shape of a hexagonal plate. The c iron oxide may be spherical. A cobalt ferrite may be cubic. The metal may be spindle-shaped. These magnetic particles are oriented in a manufacturing process of the magnetic recording medium 10.

An average particle volume of the magnetic powder may be 2300 nm³ or less, preferably 1600 nm³ or less, and more preferably 1400 nm³ or less.

An average particle size of the magnetic powder may be preferably 50 nm or less, more preferably 40 nm or less, still more preferably 30 nm or less, 25 nm or less, 22 nm or less, 21 nm or less, or 20 nm or less. The average particle size may be, for example, 10 nm or greater, preferably 12 nm or greater.

An average aspect ratio of the magnetic powder may preferably be 1.0 or greater and 3.0 or less, more preferably 1.0 or greater and 2.9 or less.

(Embodiment in which Magnetic Powder includes Hexagonal Ferrite)

According to a preferred embodiment of the present technology, the magnetic powder may include the hexagonal ferrite, and more particularly a powder of nanoparticles containing the hexagonal ferrite (hereinafter referred to as a “hexagonal ferrite particle”). The hexagonal ferrite is preferably a hexagonal ferrite having an M-type structure. The hexagonal ferrite has, for example, a hexagonal plate shape or a substantially hexagonal plate shape. The hexagonal ferrite may preferably include at least one of Ba, Sr, Pb, or Ca, more preferably at least one of Ba, Sr, or Ca. The hexagonal ferrite may specifically be one or a combination of two or more, for example selected from a barium ferrite, a strontium ferrite, and a calcium ferrite, particularly preferably the barium ferrite or the strontium ferrite. The barium ferrite may further include at least one of Sr, Pb, or Ca in addition to Ba. The strontium ferrite may further include at least one of Ba, Pb, or Ca in addition to Sr.

More specifically, the hexagonal ferrite may have an average composition represented by a general expression MFe₁₂O₁₉. Here, M is, for example, a metal of at least one of Ba, Sr, Pb, or Ca, preferably a metal of at least one of Ba or Sr. M may be a combination of Ba and one or more metals selected from the group consisting of Sr, Pb, and Ca. Further, M may be a combination of Sr and one or more metals selected from the group consisting of Ba, Pb, and Ca. In the above general expression, a part of Fe may be substituted with another metal element.

In a case where the magnetic powder includes the powder of the hexagonal ferrite particle, an average particle size of the magnetic powder may be preferably 50 nm or less, more preferably 40 nm or less, still more preferably 30 nm or less, 25 nm or less, 22 nm or less, 21 nm or less, or 20 nm or less. The average particle size may be, for example, 10 nm or greater, preferably 12 nm or greater, and more preferably 15 nm or greater. For example, the average particle size of the magnetic powder may be greater than or equal to 10 nm and less than or equal to 50 nm, greater than or equal to 10 nm and less than or equal to 40 nm, greater than or equal to 12 nm and less than or equal to 30 nm, greater than or equal to 12 nm and less than or equal to 25 nm, or greater than or equal to 15 nm and less than or equal to 22 nm. If the average particle size of the magnetic powder is less than or equal to an upper limit value described above (e.g., 50 nm or less, particularly 30 nm or less), it is possible to achieve a good electromagnetic conversion characteristic (e.g., SNR) in the magnetic recording medium 10 having the high recording density. If the average particle size of the magnetic powder is greater than or equal to a lower limit value described above (for example, 10 nm or greater, preferably 12 nm or greater), a dispersion property of the magnetic powder is further improved, making it possible to achieve a better electromagnetic conversion characteristic (for example, SNR).

In a case where the magnetic powder includes the powder of the hexagonal ferrite particle, an average aspect ratio of the magnetic powder may be preferably 1.0 or greater and 3.0 or less, more preferably 1.0 or greater and 2.9 or less, and still more preferably 2.0 or greater and 2.9 or less. If the average aspect ratio of the magnetic powder is within a numerical range described above, it is possible to suppress the aggregation of the magnetic powder and further to suppress resistance to be applied to the magnetic powder at the time of a perpendicular orientation of the magnetic powder in a process of forming the magnetic layer 13. This may result in an improved perpendicular orientation property of the magnetic powder.

In a case where the magnetic powder includes the powder of the hexagonal ferrite particle, the average particle size and the average aspect ratio of the magnetic powder are determined as follows.

First, the magnetic recording medium 10 to be measured is processed by the FIB (Focused Ion Beam) method or the like to be thin-sectioned. In a case of using the FIB method, a carbon film and a tungsten thin film are formed as protective films as a pretreatment for observing a TEM image of a cross section described later. The carbon film is formed by an evaporation method on the magnetic-layer-side surface and the back-layer-side surface of the magnetic recording medium 10, and the tungsten film is further formed on the magnetic-layer-side surface by the evaporation method or a sputtering method. The thin-sectioning takes place in the length direction (the longitudinal direction) of the magnetic recording medium 10. That is, the thin-sectioning forms a cross-section that is parallel to both the longitudinal direction and the thickness direction of the magnetic recording medium 10.

A cross-sectional observation of the cross-section of the thus-obtained thin-sectioned sample is performed using a transmission electron microscope (H-9500 manufactured by Hitachi High Technologies Corporation) at the accelerating voltage: 200 kV and a total magnification of 500,000 in such a manner that the magnetic layer 13 as a whole is included in the thickness direction of the magnetic layer 13 to take a TEM photograph.

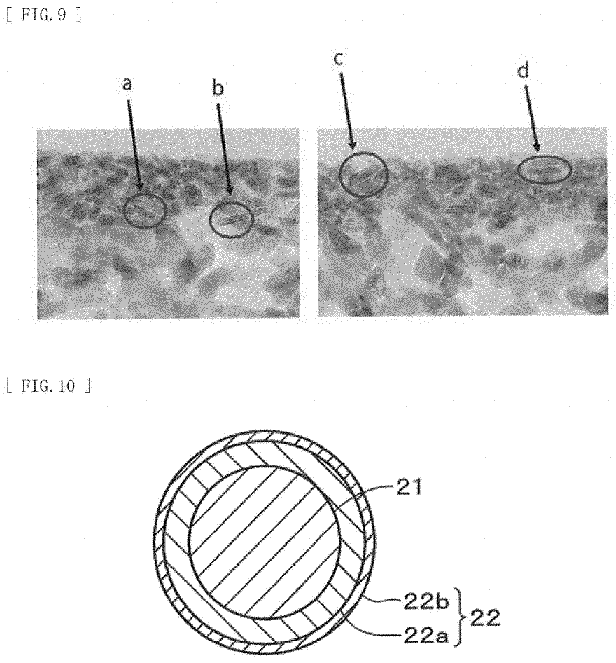

Next, 50 particles in each of which a side face is oriented in a direction of an observation surface and a thickness is clearly confirmable are selected from the photographed TEM photograph. For example, FIG. 9 illustrates an example of the TEM photograph. In FIG. 9, the particles, e.g., denoted by a and d, are selected because their thicknesses are clearly confirmable. A maximum plate thickness DA of each of the 50 selected particles is measured. The maximum plate thicknesses DA thus determined are simply averaged (an arithmetic average) to determine an average maximum plate thickness DAave.

Subsequently, a plate diameter DB of each magnetic powder is measured. In order to measure the plate diameter DB of the particles, 50 particles in each of which a plate diameter of the particle is clearly confirmable are selected from the photographed TEM photograph. For example, in FIG. 9, the particles, e.g., denoted by b and c, are selected because their plate diameters are clearly confirmable. The plate diameter DB of each of the 50 selected particles is measured. The plate diameters DB thus determined are simply averaged (an arithmetic average) to determine an average plate thickness DBₐᵥₑ. The average plate thickness DBₐᵥₑ is the average particle size.

Further, an average aspect ratio (DBₐᵥₑ/DAₐᵥₑ) of the particle is determined from the average maximum plate thickness DAₐᵥₑ and the average plate thickness DBₐᵥₑ.

In a case where the magnetic powder includes the powder of the hexagonal ferrite particle, an average particle volume of the magnetic powder may be less than or equal to 2300 nm³, preferably less than or equal to 2000 nm³, more preferably less than or equal to 1600 nm³, and even more preferably less than or equal to 1300 nm³. The average particle volume of the magnetic powder may be preferably 500 nm³ or greater, more preferably 700 nm³ or greater.

If the average particle volume of the magnetic powder is less than or equal to an upper limit value described above (e.g., 2300 nm³ or less), it is possible to achieve a good electromagnetic conversion characteristic (e.g., SNR) in the magnetic recording medium 10 having the high recording density. If the average particle volume of the magnetic powder is greater than or equal to a lower limit value described above (e.g., 500 nm³ or greater), the dispersion property of the magnetic powder is further improved, making it possible to achieve a better electromagnetic conversion characteristic (for example, SNR).

The average particle volume of the magnetic powder is determined as follows. First, the average maximum plate thickness DAₐᵥₑ and the average plate thickness DBₐᵥₑ are determined as described above with respect to a calculation method of the average particle size of the magnetic powder. Next, an average particle volume V of the magnetic powder is determined by the following expression.

$$V = \frac{3 \sqrt{3}}{8} \times {DA}_{ave} \times {DB}_{ave} \times {DB}_{ave} \qquad [ Expression 2 ]$$

According to a particularly preferred embodiment of the present technology, the magnetic powder may be a barium ferrite magnetic powder or a strontium ferrite magnetic powder, more preferably the barium ferrite magnetic powder. The barium ferrite magnetic powder includes a magnetic particle of iron oxide having a barium ferrite as a main phase (hereinafter referred to as a “barium ferrite particle”). The barium ferrite magnetic powder is, for example, free from a drop of a coercive force even in a high-temperature and high-humidity environment and is high in data recording reliability. From such a viewpoint, the barium ferrite magnetic powder is preferable as the magnetic powder.

An average particle size of the barium ferrite magnetic powder may be 50 nm or less, more preferably 10 nm or greater and 40 nm or less, and still more preferably 12 nm or greater and 25 nm or less.

In a case where the magnetic layer 13 includes the magnetic powder as the barium ferrite magnetic powder, the average thickness tm of the magnetic layer 13 may be preferably 80 nm or less, more preferably 70 nm or less, still more preferably 60 nm or less, and even more preferably 50 nm or less. If the average thickness of the magnetic layer 13 is 80 nm or less, it is possible to uniformly record the magnetization in the thickness direction of the magnetic layer 13 in a case where the ring-type head is used as the recording head, and thereby to improve the electromagnetic conversion characteristic (e.g., SNR).

The average thickness tm of the magnetic layer 13 may be preferably 30 nm or greater, more preferably 35 nm or greater, and even more preferably 40 nm or greater. If the average thickness of the magnetic layer 13 is 30 nm or greater, it is possible to secure an output in a case where the MR-type head is used as the reproducing head, and thereby to improve the electromagnetic conversion characteristic (e.g., SNR).

A numerical range of the average thickness of the magnetic layer 13 may be defined by any of the upper limit values described above and any of the lower limit values described above, and may be preferably 30 nm≤tₘ≤80 nm, more preferably 35 nm≤tₘ≤70 nm, and still more preferably 40 nm≤tₘ≤60 nm.

In addition, the squareness ratio in the thickness direction (the perpendicular direction) of the magnetic recording medium 10 may be preferably 65% or greater, more preferably 67% or greater, and still more preferably 70% or greater.

(Embodiment in which Magnetic Powder includes ε Iron Oxide)

According to another preferred embodiment of the present technology, the magnetic powder may preferably include a powder of nanoparticles including the E iron oxide (hereinafter referred to as a “ε iron oxide particle”). The ε iron oxide particle makes it possible to obtain a high coercivity even in fine particles. The ε iron oxide included in the E iron oxide particle is preferably crystallographically oriented preferentially in the thickness direction (the perpendicular direction) of the magnetic recording medium 10.

The ε iron oxide particle has spherical or substantially spherical shapes, or have cubic or substantially cubic shapes. Because the ε iron oxide particle has the above-described shape, it is possible to reduce a contacting area of the particles in thickness direction of the medium and to suppress the aggregation of the particles in a case where the ε iron oxide particle is used as the magnetic particle, as compared with a case where the hexagonal plate-shaped barium ferrite particle is used as the magnetic particle. Therefore, it is possible to increase the dispersion property of the magnetic powder and to achieve better SNR.

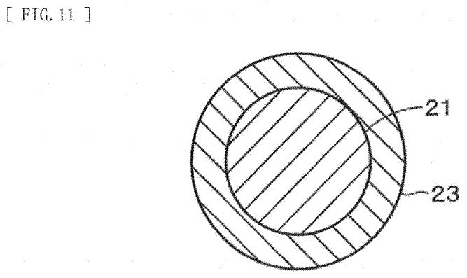

The c iron oxide particle may have a core-shell type structure. Specifically, the c iron oxide particle includes a core section 21 and a shell section 22 having a two-layer structure provided around the core section 21, as illustrated in FIG. 10. The shell section 22 having the two-layer structure includes a first shell section 22a provided on the core section 21 and a second shell section 22b provided on the first shell section 22a.

The core section 21 includes the c iron oxide. The ε iron oxide included in the core section 21 preferably includes a ε-Fe₂O₃ crystal as a main phase, more preferably includes ε-Fe₂O₃ of a single phase.

The first shell section 22a covers at least a portion of the circumference of the core section 21. Specifically, the first shell section 22a may partially cover the circumference of the core section 21 or may cover the entire circumference of the core section 21. From a viewpoint of allowing an exchange coupling between the core section 21 and the first shell section 22a to be sufficient and improving a magnetic property, it is preferable that the entire surface of the core section 21 be covered.

The first shell section 22a is a so-called soft magnetic layer, and may include, for example, a soft magnetic material such as α-Fe, an Ni—Fe alloy, or an Fe—Si—Al alloy. The α-Fe may be obtained by the reduction of the ε iron oxide included in the core section 21.

The second shell section 22b is an oxidation coating serving as an antioxidant layer. The second shell section 22b may include a iron oxide, aluminum oxide, or silicon oxide. The α iron oxide may include, for example, iron oxide of at least one of Fe₃O₄, Fe₂O₃, or FeO. In a case where the first shell section 22a includes the α-Fe (the soft magnetic material), the a-iron oxide may be obtained by the oxidation of the a-Fe included in the first shell section 22a.

The ε iron oxide particle has the first shell section 22a as described above, making it possible to secure the thermal stability. Further, because the ε iron oxide particle has the second shell section 22b as described above, it is possible to suppress a decrease in property of the ε iron oxide particle due to the exposure of the ε iron oxide particle into the air and the occurrence of rust or the like on a particle surface during a manufacturing process of the magnetic recording medium 10 and a process prior thereto. Accordingly, it is possible to suppress a degradation of a characteristic of the magnetic recording medium 10.

The ε iron oxide particle may have the shell section 23 having a single layer structure as illustrated in FIG. 11. In this case, the shell section 23 has a similar configuration to the first shell section 22a. However, from a viewpoint of suppressing a degradation of the property of the ε iron oxide particle, it is more preferable that the iron oxide particle have the shell section 22 having the two-layer structure.

The ε iron oxide particle may include an additive instead of the core-shell structure, or may have the core-shell structure and include the additive together. In these cases, a portion of Fe of the ε iron oxide particle is substituted by the additive. The additive is one or more selected from the group consisting of a metal element other than iron, preferably a trivalent metal element, more preferably aluminum (Al), gallium (Ga), and indium (In).

Specifically, the ε iron oxide including the additive is a ε-Fe₂₋ₓMₓO₃ crystal (where M is one or more selected from the group consisting of a metal element other than iron, preferably a trivalent metal element, more preferably Al, Ga, and In, and x is, for example, 0<x<1).

An average particle size (an average maximum particle size) of the magnetic powder may be preferably 22 nm or less, more preferably 8 nm or greater and 22 nm or less, and even more preferably 12 nm or greater and 22 nm or less. In the magnetic recording medium 10, a region of a size of ½ of a recording wavelength is an actual magnetization region. Accordingly, by setting the average particle size of the magnetic powder to half or less of a shortest recording wavelength, it is possible to obtain good SNR. Therefore, if the average particle size of the magnetic powder is 22 nm or less, it is possible to achieve a good electromagnetic conversion characteristic (e.g., SNR) in the magnetic recording medium 10 having the high recording density (e.g., the magnetic recording medium 10 configured to record a signal at the shortest recording wavelength of 44 nm or less). On the other hand, if the average particle size of the magnetic powder is 8 nm or greater, the dispersion property of the magnetic powder is further improved, making it possible to achieve a better electromagnetic conversion characteristic (for example, SNR).

An average aspect ratio of the magnetic powder may be preferably 1.0 or greater and 3.0 or less, more preferably 1.0 or greater and 2.9 or less, and still more preferably 1.0 or greater and 2.5 or less. If the average aspect ratio of the magnetic powder is within a numerical range described above, it is possible to suppress the aggregation of the magnetic powder and further to suppress resistance to be applied to the magnetic powder at the time of a perpendicular orientation of the magnetic powder in a process of forming the magnetic layer 13. Hence, it is possible to improve a perpendicular orientation property of the magnetic powder.

In a case where the magnetic powder includes the ε iron oxide particle, the average particle size and the average aspect ratio of the magnetic powder are determined as follows.

First, the magnetic recording medium 10 to be measured is processed by the FIB (Focused Ion Beam) method or the like to be thin-sectioned. In a case of using the FIB method, a carbon film and a tungsten thin film are formed as protective films as a pretreatment for observing a TEM image of a cross section described later. The carbon film is formed by an evaporation method on the magnetic-layer-side surface and the back-layer-side surface of the magnetic recording medium 10, and the tungsten film is further formed on the magnetic-layer-side surface by the evaporation method or a sputtering method. The thin-sectioning takes place in the length direction (the longitudinal direction) of the magnetic recording medium 10. That is, the thin-sectioning forms a cross-section that is parallel to both the longitudinal direction and the thickness direction of the magnetic recording medium 10.

A cross-sectional observation of the cross-section of the thus-obtained thin-sectioned sample is performed using a transmission electron microscope (H-9500 manufactured by Hitachi High Technologies Corporation) at the accelerating voltage: 200 kV and a total magnification of 500,000 in such a manner that the magnetic layer 13 as a whole is included in the thickness direction of the magnetic layer 13 to take a TEM photograph.

Next, 50 particles in each of which a shape of the particle is clearly confirmable are selected from the photographed TEM photograph, and a major axis length DL and a minor axis length DS of each particle are measured. Here, the major axis length DL means the largest of distances between two parallel lines drawn from every angle so as to be in contact with a contour of each particle (a so-called largest Feret's diameter). On the other hand, the minor axis length DS means the largest of lengths of the particle in a direction orthogonal to the major axis (DL) of the particle.

Subsequently, the major axis lengths DL of the 50 particles thus measured are simply averaged (an arithmetic average) to determine an average major axis length DLₐᵥₑ. The average major axis length DLₐᵥₑ thus determined is the average particle size of the magnetic powder. In addition, the minor axis lengths DS of the 50 particles thus measured are simply averaged (an arithmetic average) to determine an average minor axis length DSₐᵥₑ. Further, an average aspect ratio (DLₐᵥₑ/DSₐᵥₑ) of the particle is determined from the average major axis length DLₐᵥₑ and the average minor axis length DSₐᵥₑ.

An average particle volume of the magnetic powder may be less than or equal to 2300 nm³, preferably less than or equal to 1600 nm³, and more preferably less than or equal to 1300 nm³. The average particle volume of the magnetic powder may be preferably 500 nm³ or greater, more preferably 700 nm³ or greater.

If the average particle volume of the magnetic powder is less than or equal to an upper limit value described above (e.g., 2300 nm³ or less), it is possible to achieve a good electromagnetic conversion characteristic (e.g., SNR) in the magnetic recording medium 10 having the high recording density. If the average particle volume of the magnetic powder is greater than or equal to a lower limit value described above (e.g., 500 nm³ or greater), the dispersion property of the magnetic powder is further improved, making it possible to achieve a better electromagnetic conversion characteristic (for example, SNR).

In a case where the c iron oxide particle has a spherical or substantially spherical shape, the average particle volume of the magnetic powder is determined as follows. First, the average major axis length DLₐᵥₑ is determined in a similar manner to the calculation method of the average particle size of the magnetic powder described above. Next, an average particle volume V of the magnetic powder is determined by the following expression.

V=(π/6)×DLₐᵥₑ³

In a case where the c iron oxide particle has a cubic shape, the average particle volume of the magnetic powder is determined as follows.

The magnetic recording medium 10 is processed by the FIB (Focused Ion Beam) method or the like to be thin-sectioned. In a case of using the FIB method, a carbon film and a tungsten thin film are formed as protective films as a pretreatment for observing a TEM image of a cross section described later. The carbon film is formed by an evaporation method on the magnetic-layer-side surface and the back-layer-side surface of the magnetic recording medium 10, and the tungsten film is further formed on the magnetic-layer-side surface by the evaporation method or a sputtering method. The thin-sectioning takes place in the length direction (the longitudinal direction) of the magnetic recording medium 10. That is, the thin-sectioning forms a cross-section that is parallel to both the longitudinal direction and the thickness direction of the magnetic recording medium 10.

A cross-sectional observation of the cross-section of the thus-obtained thin-sectioned sample is performed using a transmission electron microscope (H-9500 manufactured by Hitachi High Technologies Corporation) at the accelerating voltage: 200 kV and a total magnification of 500,000 in such a manner that the magnetic layer 13 as a whole is included in the thickness direction of the magnetic layer 13 to take a TEM photograph. Note that the magnification and the accelerating voltage may be adjusted on an as-necessary basis depending on a type of an apparatus.

Next, 50 particles in each of which a shape of the particle is clearly confirmable are selected from the photographed TEM photograph, and a length DC of a side of each particle is measured. Subsequently, the lengths DC of the sides of the 50 particles thus measured are simply averaged (an arithmetic average) to determine an average side length DCₐᵥₑ. Next, the average particle volume Vₐᵥₑ of the magnetic powder (a particle volume) is determined using the average side length DCₐᵥₑ from the following expression. Vₐᵥₑ=DCₐᵥₑ³

In a case where the magnetic layer 13 includes the c iron oxide as the magnetic powder, the average thickness tm of the magnetic layer 13 may be preferably 80 nm or less, more preferably 70 nm or less, still more preferably 60 nm or less, and even more preferably 50 nm or less. If the average thickness of the magnetic layer 13 is 80 nm or less, it is possible to uniformly record the magnetization in the thickness direction of the magnetic layer 13 in a case where the ring-type head is used as the recording head, and thereby to improve the electromagnetic conversion characteristic (e.g., SNR).

The average thickness tₘ of the magnetic layer 13 may be preferably 30 nm or greater, more preferably 35 nm or greater, and even more preferably 40 nm or greater. If the average thickness of the magnetic layer 13 is 30 nm or greater, it is possible to secure an output in a case where the MR-type head is used as the reproducing head, and thereby to improve the electromagnetic conversion characteristic (e.g., SNR).

A numerical range of the average thickness of the magnetic layer 13 may be defined by any of the upper limit values described above and any of the lower limit values described above, and may be preferably 30 nm<tₘ<80 nm, more preferably 35 nm<tₘ<70 nm, and still more preferably 40 nm≤tₘ≤60 nm.

In addition, the squareness ratio in the thickness direction (the perpendicular direction) of the magnetic recording medium 10 may be preferably 65% or greater, more preferably 67% or greater, and still more preferably 70% or greater.

(Embodiment in which Magnetic Powder includes Co-Containing Spinel Ferrite)

According to yet another preferred embodiment of the present technology, the magnetic powder may include a powder of nanoparticles containing the Co-containing spinel ferrite (hereinafter referred to as a “cobalt ferrite particle”. That is, the magnetic powder may be a cobalt ferrite magnetic powder. The cobalt ferrite particle preferably has a uniaxial crystal anisotropy. The cobalt ferrite magnetic particle has, for example, a cubic shape or a substantially cubic shape. The Co-containing spinel ferrite may further include one or more selected from the group consisting of Ni, Mn, Al, Cu, and Zn in addition to Co.

The cobalt ferrite has, for example, an average composition represented by the following expression (1).

CoₓM_{y}Fe₂O_{z} (1)

(where, in the expression (1), M is one or more metals selected, for example, from the group consisting of Ni, Mn, Al, Cu, and Zn. x is a value within a range of 0.4≤x≤1.0. y is a value within a range of 0≤y≤0.3. Where x and y satisfy a relationship (x+y)≤1.0. z is a value within a range of 3≤z≤4. A portion of Fe may be substituted by any other metal element.)

An average particle size of the cobalt ferrite magnetic powder may be preferably 25 nm or less, more preferably 23 nm or less.

In a case where the magnetic powder includes the powder of the cobalt ferrite particles, the average particle size of the magnetic powder may be preferably less than or equal to 25 nm, more preferably greater than or equal to 10 nm and less than or equal to 23 nm. If the average particle size of the magnetic powder is less than or equal to 25 nm, it is possible to achieve a good electromagnetic conversion characteristic (e.g., SNR) in the magnetic recording medium 10 having the high recording density. If the average particle size of the magnetic powder is greater than or equal to 10 nm, the dispersion property of the magnetic powder is further improved, making it possible to achieve a better electromagnetic conversion characteristic (for example, SNR). In a case where the magnetic powder includes the powder of the cobalt ferrite particles, an average aspect ratio and an average particle size of the magnetic powder are determined by methods similar to those of a case where the magnetic powder includes the ε iron oxide particle.

An average particle volume of the magnetic powder may be less than or equal to 2300 nm³, preferably less than or equal to 1600 nm³, and more preferably less than or equal to 1300 nm³. The average particle volume of the magnetic powder may be preferably 500 nm³ or greater, more preferably 700 nm³ or greater.

If the average particle volume of the magnetic powder is less than or equal to an upper limit value described above (e.g., 2300 nm³ or less), it is possible to achieve a good electromagnetic conversion characteristic (e.g., SNR) in the magnetic recording medium 10 having the high recording density. If the average particle volume of the magnetic powder is greater than or equal to a lower limit value described above (e.g., 500 nm³ or greater), the dispersion property of the magnetic powder is further improved, making it possible to achieve a better electromagnetic conversion characteristic (for example, SNR).

In a case where the magnetic layer 13 includes the Co-containing spinel ferrite as the magnetic powder, the average thickness tm of the magnetic layer 13 may be preferably 80 nm or less, more preferably 70 nm or less, still more preferably 60 nm or less, and even more preferably 50 nm or less. If the average thickness of the magnetic layer 13 is 80 nm or less, it is possible to uniformly record the magnetization in the thickness direction of the magnetic layer 13 in a case where the ring-type head is used as the recording head, and thereby to improve the electromagnetic conversion characteristic (e.g., SNR).

The average thickness tₘ of the magnetic layer 13 may be preferably 30 nm or greater, more preferably 35 nm or greater, and even more preferably 40 nm or greater. If the average thickness of the magnetic layer 13 is 30 nm or greater, it is possible to secure an output in a case where the MR-type head is used as the reproducing head, and thereby to improve the electromagnetic conversion characteristic (e.g., SNR).

A numerical range of the average thickness of the magnetic layer 13 may be defined by any of the upper limit values described above and any of the lower limit values described above, and may be preferably 30 nm≤tₘ≤80 nm, more preferably 35 nm≤tₘ≤70 nm, and still more preferably 40 nm≤t_{m≤}60 nm.

In addition, the squareness ratio in the thickness direction (the perpendicular direction) of the magnetic recording medium 10 may be preferably 65% or greater, more preferably 67% or greater, and still more preferably 70% or greater.

(Binder)

As a binder, a resin having a structure in which a crosslinking reaction is performed on a polyurethane-based resin, a vinyl chloride-based resin, or the like is preferred. However, the binder is not limited thereto, and any other resin may be blended on an as-necessary basis depending on, for example, a physical property demanded for the magnetic recording medium 10. The resin to be blended is not particularly limited as long as the resin to be blended is a resin typically used in the coating type magnetic recording medium 10.

As the binder, for example, one or a combination of two or more selected from polyvinyl chloride, polyvinyl acetate, vinyl chloride-vinyl acetate copolymer, vinyl chloride-vinylidene chloride copolymer, vinyl chloride-acrylonitrile copolymer, acrylic acid ester-acrylonitrile copolymer, acrylic acid ester-vinyl chloride-vinylidene chloride copolymer, acrylic acid ester-vinylidene chloride copolymer, methacrylic acid ester-vinylidene chloride copolymer, methacrylic acid ester-vinyl chloride copolymer, methacrylic acid ester-ethylene copolymer, polyvinyl fluoride, vinylidene chloride-acrylonitrile copolymer, acrylonitrile-butadiene copolymer, polyamide resin, polyvinyl butyral, cellulose derivatives (cellulose acetate butyrate, cellulose diacetate, cellulose triacetate, cellulose propionate, nitrocellulose), styrene butadiene copolymer, polyester resin, amino resin, and synthetic rubber may be used.

Further, as the binder, a thermosetting resin or a reactive resin may be used. Examples of the thermosetting resin or the reactive resin include phenolic resin, epoxy resin, urea resin, melamine resin, alkyd resin, silicone resin, polyamine resin, and urea formaldehyde resin.

In addition, a polar functional group such as —SO₃M, —OSO₃M, —COOM, or P═O(OM)₂ may be introduced into each of the binders described above for a purpose of improving the dispersion property of the magnetic powder. Here, in the expression, M is a hydrogen atom, or an alkali metal such as, for example, lithium, potassium, or sodium.

Further, examples of the polar functional group include that of a side chain type having a terminal group of —NR1R2, —NR1R2R3⁺X⁻, and that of a main chain type of >NR1R2⁺X⁻. Where, in the expressions, R1, R2, and R3 are independently a hydrogen atom or a hydrocarbon group from each other, and X⁻ is, for example, a halogen element ion such as fluorine, chlorine, bromine, or iodine, or an inorganic or organic ion. Further, examples of the polar functional group include —OH, —SH, —CN, or epoxy groups. An amount of the polar functional groups to be introduced into the binder is preferably 10⁻¹ to 10⁻⁸ mol/g, more preferably 10⁻² to 10⁻⁶ mol/g.

(Lubricant)

The magnetic layer may include a lubricant. The lubricant may be, for example, one or two or more selected from fatty acid and/or fatty acid ester, and may preferably include both the fatty acid and the fatty acid ester. The fatty acid may be preferably a compound represented by the following general chemical formula (1) or general chemical formula (2). For example, one of the compound represented by the following general chemical formula (1) and the compound represented by the following general chemical formula (2) may be contained as the fatty acid, or both of them may be contained.

Further, the fatty acid ester may be preferably a compound represented by the following general chemical formula (3) or the following general chemical formula (4). For example, one of the compound represented by the following general chemical formula (3) and the compound represented by the following general chemical formula (4) may be contained as the fatty acid ester, or both of them may be contained.

The lubricant that includes either or both of the compound represented by the general chemical formula (1) and the compound represented by the general chemical formula (2) and either or both of the compound represented by the general chemical formula (3) and the compound represented by the general chemical formula (4) makes it possible to suppress an increase in dynamic friction coefficient resulting from repeated recording or reproduction of the magnetic recording medium.

CH₃(CH₂)ₖCOOH (1)

(where, in the general chemical formula (1), k is an integer selected from a range of 14 or greater and 22 or less, more preferably a range of 14 or greater and 18 or less.)

CH₃(CH₂)ₙCH═CH(CH₂)ₘCOOH (2)

(where, in the general chemical formula (2), the sum of n and m is an integer selected from a range of 12 or greater and 20 or less, more preferably a range of 14 or greater and 18 or less.)

CH₃(CH₂)ₚCOO(CH₂)_{q}CH₃ (3)

(where, in the general chemical formula (3), p is an integer selected from a range of 14 or greater and 22 or less, more preferably 14 or greater and 18 or less, and q is an integer selected from a range of 2 or greater and 5 or less, and more preferably a range of 2 or greater and 4 or less.)

CH₃(CH₂)ᵣCOO—(CH₂)ₛCH(CH₃)₂ (4)

(where, in the general chemical formula (4), r is an integer selected from a range of 14 or greater and 22 or less, and s is an integer selected from a range of 1 or greater and 3 or less.)

Examples of the lubricant include esters of monobasic fatty acids having 10 to 24 carbon atoms and any of 1 to 6 valent alcohols having 2 to 12 carbon atoms, mixed esters thereof, difatty acid esters, and trifatty acid esters. Specific examples of the lubricant include lauric acid, myristic acid, palmitic acid, stearic acid, behenic acid, oleic acid, linoleic acid, linolenic acid, elidic acid, butyl stearate, pentyl stearate, heptyl stearate, octyl stearate, isooctyl stearate, and octyl myristate.

(Antistatic Agent)

Examples of an antistatic agent include carbon black, natural surfactants, nonionic surfactants, and cationic surfactants.

(Abrasive)

Examples of an abrasive include a-alumina whose pregelatinized rate is 90% or greater, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, needle-shaped α iron oxide obtained by the dehydration of a raw material of magnetic iron oxide and the anneal process, and any of those having been subjected to a surface treatment with aluminum and/or silica as necessary.

(Hardener)

Examples of a hardener include polyisocyanates. Examples of the polyisocyanate include aromatic polyisocyanates such as an adduct of tolylene diisocyanate (TDI) and an active hydrogen compound, and aliphatic polyisocyanates such as an adduct of hexamethylene diisocyanate (HMDI) and the active hydrogen compound. A weight average molecular weight of the polyisocyanates is desirably in a range of 100 to 4500.

(Antirust Agent)

Examples of an antirust agent include phenols, naphthols, quinones, heterocyclic compounds containing a nitrogen atom, heterocyclic compounds containing an oxygen atom, and heterocyclic compounds containing a sulfur atom.

(Non-Magnetic Reinforcing Particle)

Examples of a non-magnetic reinforcing particle include aluminum oxide (α, β, or γ alumina), chromium oxide, silicon oxide, diamonds, garnets, emeries, boron nitride, titanium carbide, silicon carbide, titanium carbide, and titanium oxide (rutile or anatase-type titanium oxide).

(Foundation Layer)

The foundation layer 12 is a non-magnetic layer including a non-magnetic powder and a binder. The foundation layer 12 may further include, on an as-necessary basis, at least one additive of the lubricant, the antistatic agent, the hardener, the antirust agent, and the like.

An average thickness of the foundation layer 12 may be preferably 0.6 μm or greater and 2.0 μm or less, more preferably 0.6 μm or greater and 1.4 μm or less. More desirably, the average thickness of the foundation layer 12 may be 0.6 μm or greater and 1.0 μm or less. The average thickness of the foundation layer 12 is determined in a manner similar to that of the average thickness of the magnetic layer 13. However, a magnification of a TEM image is adjusted on an as-necessary basis depending on the thickness of the foundation layer 12.

In a preferred embodiment of the present technology, the foundation layer 12 is provided between the magnetic layer 13 and the base layer 11, and the average thickness of the foundation layer 12 may be 2.0 μm or less.

(Non-Magnetic Powder)

A non-magnetic powder includes, for example, at least one of an inorganic particle powder or an organic particle powder. Further, the non-magnetic powder may include a carbon powder such as carbon black. Note that one type of non-magnetic powder may be used alone, or two or more types of non-magnetic powder may be used in combination. The inorganic particles include, for example, metals, metal oxides, metal carbonates, metal sulfates, metal nitrides, metal carbides, metal sulfides, or the like. Examples of a shape of the non-magnetic powder include various shapes such as a needle-shape, a spherical shape, a cubic shape, and a plate shape, although the shape of the non-magnetic powder is not limited thereto.

(Binder)

The description on the binder included in the magnetic layer 13 described above also applies to a binder included in the foundation layer.

(Additive)

The descriptions on the lubricant, the antistatic agent, the hardener, and the antirust agent included in the magnetic layer 13 described above also apply to a lubricant, an antistatic agent, a hardener, and an antirust agent included in the foundation layer.

(Back Layer)

The back layer 14 may include a binder and a non-magnetic powder. The back layer 14 may further include at least one additive of a lubricant, a hardener, an antistatic agent, and the like on an as-necessary basis. The descriptions on the binder and the non-magnetic powder included in the foundation layer 12 described above also apply to the binder and the non-magnetic powder included in the back layer.

An average particle size of the non-magnetic powder may be preferably 10 nm or greater and 150 nm or less, more preferably 15 nm or greater and 110 nm or less. The average particle size of the non-magnetic powder is determined in a similar manner to the average particle size of the magnetic powder described above. The non-magnetic powder may include a non-magnetic powder having two or more particle size distributions.

An average thickness of the back layer 14 (also referred to in the present specification as an “average thickness t_{b}” or “t_{b}”) is preferably 0.6 μm or less. The average thickness of the back layer 14 may be more desirably 0.4 μm or less, may be more desirably 0.3 μm or less. If the average thickness b of the back layer 14 is within a range described above, it is possible to keep the thicknesses of the foundation layer 12 and the base layer 11 thick and thereby to maintain a traveling stability of the magnetic recording medium 10 in the recording reproducing apparatus, even in a case where the average thickness of the magnetic recording medium 10 is thin, for example, 5.8 μm or less. A lower limit value of the average thickness b of the back layer 14 is not particularly limited, but is, for example, 0.2 μm or greater.

In a preferred embodiment of the present technology, of two faces of the base layer 11, the back layer 14 is provided on the face that is on an opposite side of the face on which the magnetic layer 13 is provided, and the average thickness of the back layer 14 may be 0.6 μm or less.

The average thickness tb of the back layer 14 is determined as follows. First, the average thickness t_{T} of the magnetic recording medium 10 is measured. A method of measuring the average thickness t_{T} is as described in the present specification below. Subsequently, the back layer 14 of a sample is removed with a solvent such as MEK (methyl ethyl ketone) or dilute hydrochloric acid. Next, using the laser hologage (LGH-110C) manufactured by Mitutoyo Corporation, a thickness of the sample is measured at positions of five or more, and measurement values at those positions are simply averaged (an arithmetic average) to calculate an average value t_{B}[μm]. Thereafter, the average thickness t_{b}[μm] of the back layer 14 is determined from the following expression. Note that the measurement positions are randomly selected from the sample.

t_{b}[μm]=t_{T}[μm]−t_{B}[μm]

(Average Thickness t_{T} of Magnetic Recording Medium)

An average thickness of the magnetic recording medium 10 (also referred to in the present specification as an “average thickness t_{T}” or “t_{T}”, may be preferably 5.8 μm or less, more preferably 5.6 μm or less, more preferably 5.5 μm or less, still more preferably 5.4 μm or less, preferably 5.3 μm or less, more preferably 5.2 μm or less, still more preferably 5.1 μm or less, 5.0 μm or less, 4.8 μm or less, or 4.6 μm or less. If the average thickness t_{T} of the magnetic recording medium 10 is within a numerical range described above (for example, t_{T}≤5.3 μm), it is possible to increase the recording capacity that allows for recording in one data cartridge as compared with a typical magnetic recording medium. A lower limit value of the average thickness t_{T} of the magnetic recording medium 10 is not particularly limited, but is, for example, 3.5 μm≤t_{T}.

The average thickness t_{T} of the magnetic recording medium 10 is determined as follows. First, the magnetic recording medium 10 having a width of ½ inch is prepared and the magnetic recording medium 10 is cut into a length of 250 mm to fabricate a sample. Next, using the laser hologage (LGH-110C) manufactured by Mitutoyo Corporation as a measurement apparatus, a thickness of the sample is measured at positions of five or more, and measurement values at those positions are simply averaged (an arithmetic average) to calculate an average value t_{T}[μm]. Note that the measurement positions are randomly selected from the sample.

In the present technology, in a case where a layer structure having the magnetic layer 13, the foundation layer 12, and the base layer 11 in this order is used, a ratio of (the average thickness of the magnetic layer 13+the average thickness of the foundation layer 12)/(the average thickness of the base layer 11) may be preferably 0.15 or greater, more preferably 0.16 or greater, from a viewpoint that coating films forming the magnetic layer 13 and the foundation layer 12 have a higher Young's modulus than the base layer 11, are stronger in tension, and withstand even when a tension is applied if the base layer 11 is thin and the coating films are higher in proportion. The ratio may be, for example, preferably 0.35 or less, more preferably 0.33 or less, and still more preferably 0.30 or less.

In addition, from the same viewpoint as described above, a ratio of (the average thickness of the magnetic layer 13+the average thickness of the foundation layer 12+the average thickness of the back layer 14)/(the average thickness of the magnetic recording medium 10) may be preferably 0.17 or greater, more preferably 0.18 or greater, and still more preferably 0.19 or greater. The ratio may be, for example, preferably 0.30 or less, more preferably 0.28 or less, and still more preferably 0.25 or less.

(Magnetic Interaction ΔM)

The magnetic interaction ΔM is determined as follows. First, both sides of the magnetic recording medium 10 are reinforced with tapes, and then punched with a punch of φ6 mm to fabricate a measurement sample. At this time, a marking is performed with any ink having no magnetic property so that the longitudinal direction (the traveling direction) of the magnetic recording medium is recognizable. Upon attaching the sample to a sample bar, the attachment was so performed as to allow the longitudinal direction of the magnetic recording medium (a tape) to be perpendicular to the sample bar. Thereafter, the measurement sample is demagnetized using a degaussing machine.

A specific operation procedure is as follows.
(1) Turn on a power supply (Model 642 Electromagnet Power Supply manufactured by Lake Shore Inc.) of a vibrating sample magnetometer (Vibrating Sample Magnetometer: VSM) (VSM-vibrating sample type 7400-S series, manufactured by Lake Shore Inc.), and start a chiller (a circulating device) of a coolant to operate an apparatus.
(2) Turn on the power supply of the vibrating sample magnetometer.
(3) Launch IDEAS-VSM version4 software.
(4) Wipe a sample holder with ethanol, apply a double-sided tape to the sample holder, and attach a standard-Ni sample (70.6 mg, 3.876 emu) thereon.
(5) Turn on a power supply of an ionizer to remove static electricity of the sample holder.
(6) Attach the sample horizontally with respect to an applied magnetic field of the vibrating sample magnetometer and perform a magnetization calibration with 15000 G.
(7) Set Calibration to moment gain and click Yes. Set Single Point Calibration to OK, input emu as a standard-Ni-sample value, input Field as 15000 G, and press OK to perform the magnetization calibration.
(8) In Angle set of Ramp To, set an Angle value on the left side to +90°, and rotate a knob in an X-axis to a position where the sample holder does not collide to move the sample holder.
(9) Set Field of Ramp to to 15000 G and click OK. Drive Head Drive.
(10) Check VSM Controller, Chart Recorder, Moment X, and Moment of Displays, and set them to OK.
(11) Align knobs in a Y-axis and the X-axis to bring the sample holder to the center.
(12) After adjusting a position of the sample holder, close the VSM Controller.
(13) Stop driving of the Head Drive, input Field as 0 at Ramp to, and demagnetize the sample holder.
(14) Thereafter, remove the sample holder from the vibrating sample magnetometer and remove the standard Ni-sample.
(15) With only the double-sided tape being attached, enter OK in Moment offset of Calibrations to perform the offset, and attach a measurement sample.
(16) Thereafter, in Experiment, select a desired measuring-mode condition.
(17) Press Start to begin a measurement.
(18) After the measurement is completed, stop the driving of the Head Drive and replace the measurement sample.
(19) After the measurement is completed, the apparatus is stopped in the reverse order to that at the time of starting the apparatus.

More specifically, for the measurement sample, a remanent magnetization Ir(H) measured as a result of an alternating-current demagnetization is measured by the following method. The alternating-current demagnetization is performed and an external magnetic field is set to 0 Oe. Thereafter, a remanent magnetization at the time of returning to 0 Oe after 200 Oe application of a magnetic field in a certain one direction is defined as Ir (200 Oe), and a remanent magnetization at the time of returning to 0 Oe after further application of 200 Oe+200 Oe (400 Oe) is defined as Ir (400 Oe), and these operations are performed for each 200 Oe, and the magnetic field is increased to 6 kOe. A remanent magnetization when the applied magnetic field is 6 kOe is defined as(∞).

Next, a remanent magnetization Id(H) measured as a result of a direct-current demagnetization is measured by the following method. The direct-current demagnetization is performed by applying an external magnetic field of 10 kOe and the external magnetic field is set to 0 Oe. Thereafter, a remanent magnetization at the time of returning to 0 Oe after 200 Oe application of a magnetic field in a direction opposite to the direction of the magnetic field upon the direct-current demagnetization is defined as Id (200 Oe), and a remanent magnetization at the time of returning to 0 Oe after application of 200 Oe+200 Oe (400 Oe) following further additional direct-current demagnetization is defined as Id (400 Oe), and these operations are performed for each 200 Oe, and the magnetic field is increased to 6 kOe.

As described above with reference to FIG. 6, each ΔM(H) is calculated by the expression (1) using each Id(H), each Ir(H), and Ir(∞) thus obtained, and a smallest value of the calculated ΔM(H) is defined as the magnetic interaction ΔM of the measurement sample.

However, at the time of the measurement, the correction is performed as Md(H)=Id(H)/Id(0), Mr(H)={Ir(H)−Ir(0)}/{Ir(∞)−Ir(0))}. This is because Ir(∞)≈Id(0) holds true but they are not perfectly matched. Further, this is because Ir(0) is not completely demagnetized and does not become zero.

(Thermal Stability)

From a viewpoint of preventing a deterioration of a reproduction output, the thermal stability KᵤV_{act}/k_{B}T of the magnetic recording medium according to the present technology may be, for example, preferably 63 or greater, more preferably 70 or greater, still more preferably 80 or greater, and still more preferably 90 or greater. The magnetic recording medium according to the present technology has such a high thermal stability and is thereby excellent in preservation stability, despite containing the magnetic powder having the small average particle volume.

The thermal stability KᵤV_{act}/k_{B}T of the magnetic recording medium according to the present technology may preferably be less than or equal to 150.

It is possible to achieve the thermal stability KᵤV_{act}/k_{B}T of the magnetic recording medium, for example, by stabilizing a material state following a glass dissolution upon a synthesizing step of the magnetic powder. For example, although a dissolution temperature is set to any dissolution temperature at the time of the glass dissolution, an amorphous state of a material following the glass dissolution is further uniformized by setting the dissolution temperature at this time to a high temperature, thereby making it possible to stabilize the material state. Further, it is also possible to adjust the thermal stability KᵤV_{act}/k_{B}T by improving a magnitude of perpendicular orientation.

The thermal stability KᵤV_{act}/k_{B}T of the magnetic recording medium (Kᵤ: a crystal magnetic anisotropic constant of the magnetic powder, V_{act}: an activation volume of the magnetic powder, k_{B}: a Boltzmann constant, T: an absolute temperature) is calculated using the Sharrock expression represented below (reference: IEEE TRANSACTIONS ON MAGNETICS, VOL. 50, NO. 11, NOVEMBER 2014, and J. Flanders and M. P. Sharrock: J. Appl. Phys., 62, 2918 (1987)).

Hᵣ(t′)=H₀[1−{k_{B}T/(KᵤV_{act})1n(f₀t′0.693)ⁿ}]

(where Hᵣ: a residual magnetic field, t′: a magnetization attenuation amount, H₀: a magnetic field change amount, k_{B}: a Boltzmann constant, T: an absolute temperature, Kᵤ: a crystal magnetic anisotropic constant, V_{act}: an activation volume of the magnetic powder, f₀: a frequency factor, and n: a coefficient)

Note that (a) the residual magnetic field Hᵣ, (b) the magnetization attenuation amount t′, and (c) the magnetic field change amount H₀ are determined as follows. In addition, the following numerical values are used for (d) the frequency factor f₀ and (e) the coefficient n. Further, the absolute temperature T is 25° C.

(a) It is possible to measure the residual magnetic field Hᵣ by the pulse VSM “HR-PVSM20” manufactured by Hayama Inc. Three sheets of magnetic recording medium 10 are superimposed on each other by a double-sided tape, and are then punched out by a φ6 mm punch, and a thus-obtained sample is used for a measurement. A magnetic field of 6358[Oe] is applied to the sample prior to starting of the measurement to magnetically orient the sample in one direction. Thereafter, a magnetic field is intermittently applied every 505.75[Oe] from 0 to 20230[Oe], and a magnetization amount at that time is measured to plot values with the applied magnetic field being an X axis and the magnetization amount being a Y axis. X when Y=0 is established in the thus-obtained graph is the residual magnetic field Hᵣ.

(b) The magnetization attenuation amount t′ is determined as follows. That is, an external magnetic field in the vicinity of the coercivity Hc of the magnetic recording medium 10 to be measured is applied under three conditions, three sheets of magnetic recording medium 10 are superimposed on each other by a double-sided tape, and are then punched out by a φ6 mm punch, and a thus-obtained sample is used to measure the magnetization attenuation amount by a vibrating sample magnetometer (Vibrating Sample Magnetometer: VSM). Further, from the magnetization attenuation amount, the magnetization attenuation amount t′ is calculated using the Flanders expression described in the following reference (reference: I. P. J. Flanders and M. P. Sharrock, “An analysis of time-dependent magnetization and coercivity and of their relationship to print-through in recording tapes, ” J. Appl. Phys., vol. 62, pp. 2918-2928, 1987).

Here, the “coercivity Hc” means the coercivity Hc in a direction of orientation of the magnetic powder. That is, in a case where the magnetic powder is oriented in a perpendicular direction, the “coercivity Hc” means a coercivity Hc1 in the perpendicular direction. On the other hand, in a case where the magnetic powder is oriented in a longitudinal direction, the “coercivity Hc” means a coercivity Hc2 in the longitudinal direction. In a case where the magnetic powder is not oriented, that is, in a case where the magnetic power is non-oriented, the coercivity Hc1 in the perpendicular direction is used as the coercivity Hc.

In addition, “the external magnetic field of the three conditions” means a magnetic field equal to or greater than the coercivity Hc (a magnetic field by which a positive magnetization is obtained), a magnetic field close to the coercivity Hc (a magnetic field by which a magnetization close to 0 is obtained), and a magnetic field less than the coercivity Hc (a magnetic field by which a negative magnetization is obtained). As a specific example, in a case where a perpendicular orientation tape Hc=2600[Oe], “the external magnetic field of the three conditions” is calculated as a magnetic field by which the positive magnetization is obtained=2400 [Oe], a magnetic field close to the coercivity Hc=2600[Oe], and a magnetic field by the negative magnetization is obtained=2800[Oe]. It should be noted, however, that the numerical values given as a specific example do not limit a numerical range in an actual measurement.

(c) The magnetic field change amount Ho is a constant calculated by substituting the measurement magnetic field and the magnetization attenuation amount measured in (b) into the Sharrock expression.

(d) The frequency factor fo is a constant value and is defined as f0=5.0×10⁹ Hz.

(e) The coefficient n is set to a value corresponding to a crystal magnetic anisotropy of the magnetic powder. In a case where the magnetic powder has a uniaxial crystal magnetic anisotropy and the magnetic tape is subjected to the perpendicular orientation, the coefficient n is set as n=0.5. On the other hand, in a case where the magnetic powder has a multiaxial crystal magnetic anisotropy (a triaxial crystal magnetic anisotropy) or in a case where the magnetic powder has the uniaxial crystal magnetic anisotropy but the magnetic tape is non-oriented, the coefficient n is set as n=0.77.

(Squareness Ratio Rs2 in Perpendicular Direction)

A squareness ratio Rs2 in the perpendicular direction (the thickness direction) of the magnetic recording medium according to the present technology may be preferably 65% or greater, more preferably 67% or greater, and even more preferably 70% or greater. If the squareness ratio Rs2 is 65% or greater, the perpendicular orientation property of the magnetic powder becomes sufficiently high, making it possible to achieve better SNR. Therefore, it is possible to achieve a better electromagnetic conversion characteristic. In addition, a servo signal shape is improved, making it easier to perform a control on the drive side.

In this specification, the perpendicular orientation of the magnetic recording medium may mean that the squareness ratio Rs2 of the magnetic recording medium is within a numerical range described above (e.g., 65% or greater).

The squareness ratio Rs2 in the perpendicular direction is determined as follows. First, the magnetic recording medium 10 is punched to 6.25 mm×64 mm, following which the punched magnetic recording medium 10 is folded in three to fabricate a measurement sample of 6.25 mm×8 mm. Further, an M-H hysteretic loop of the measurement sample (the magnetic recording medium 10 as a whole) corresponding to the perpendicular direction (the thickness direction) of the magnetic recording medium 10 is measured using the VSM. Next, acetone, ethanol, or the like is used to remove coating films (such as the foundation layer 12, the magnetic layer 13, or the back layer 14) to leave only the base layer 11. Further, the thus-obtained base layer 11 is punched into 6.25 mm×64 mm and the punched base layer 11 is folded in three to obtain a sample for a background correction (hereinafter simply referred to as a “correction sample”) of 6.25 mm×8 mm. Thereafter, an M-H hysteretic loop of the correction sample (the base layer 11) corresponding to the perpendicular direction of the base layer 11 (the perpendicular direction of the magnetic recording medium 10) is measured using the VSM.

In measuring the M-H hysteresis loop of the measurement sample (the magnetic recording medium 10 as a whole) and the M-H hysteresis loop of the correction sample (the base layer 11), a high-sensitivity vibrating sample magnetometer “VSM-P7-15 type” manufactured by Toei Industry Co., Ltd. is used. Measurement conditions include a measurement mode; full-loop, a maximum magnetic field:15 kOe, a magnetic field step: 40 bit, Time constant of Locking amp: 0.3 sec, Waiting time: 1 sec, and MH-average: 20.

After the M-H hysteresis loop of the measurement sample (the magnetic recording medium 10 as a whole) and the M-H hysteresis loop of the correction sample (the base layer 11) are obtained, the M-H hysteresis loop of the correction sample (the base layer 11) is subtracted from the M-H hysteresis loop of the measurement sample (the magnetic recording medium 10 as a whole) to perform the background correction, and an M-H hysteresis loop following the background correction is obtained. To perform a calculation of the background correction, measurement and analysis programs attached to the “VSM-P7-15 type” are used.

A saturation magnetization amount Ms(emu) and a remanent magnetization Mr(emu) of the thus-obtained M-H hysteretic loop following the background correction are substituted into the following expression to calculate a squareness ratio Rs2(%). The measurements of the M-H hysteresis loops described above are each performed at 25° C. In addition, a “diamagnetic field correction” upon measuring the M-H hysteretic loop in the perpendicular direction of the magnetic recording medium 10 is not performed. It should be noted that, for this calculation, the measurement and analysis programs attached to the “VSM-P7-15 type” are used.

Squareness ratio Rs2(%)=(Mr/Ms)×100

(Squareness Ratio Rs1 in Longitudinal Direction)

A squareness ratio Rs1 in the longitudinal direction (the traveling direction) of the magnetic recording medium 10 may be preferably 35% or less, more preferably 27% or less, and even more preferably 20% or less. If the squareness ratio Rs1 in the longitudinal direction is 35% or less, the perpendicular orientation property of the magnetic powder becomes sufficiently high, making it possible to achieve better SNR. Therefore, it is possible to achieve a better electromagnetic conversion characteristic. In addition, the servo signal shape is improved, making it easier to perform the control on the drive side.

In this specification, the perpendicular orientation of the magnetic recording medium may mean that the squareness ratio Rs1 in the longitudinal direction of the magnetic recording medium is within a numerical range described above (e.g., 35% or less). The magnetic recording medium according to the present technology is preferably oriented perpendicularly.

The squareness ratio Rs1 in the longitudinal direction is determined in a manner similar to that of the squareness ratio Rs2 in the perpendicular direction, except that the M-H hysteretic loop is measured in the longitudinal direction (the traveling direction) of the magnetic recording medium 10 and the base layer 11.

The squareness ratio Rs2 in the perpendicular direction and the squareness ratio Rs1 in the longitudinal direction are set to desired values by adjusting, for example, an intensity of a magnetic field to be applied to a magnetic layer formation paint, a duration of the application of the magnetic field to the magnetic layer formation paint, a dispersion state of the magnetic powder in the magnetic layer formation paint, or a concentration of a solid content in the magnetic layer formation paint. Specifically, for example, as the intensity of the magnetic field becomes higher, the squareness ratio Rs1 in the longitudinal direction becomes smaller while the squareness ratio Rs2 in the perpendicular direction becomes larger. In addition, as the duration of the application of the magnetic field becomes longer, the squareness ratio Rs1 in the longitudinal direction becomes smaller while the squareness ratio Rs2 in the perpendicular direction becomes larger. In addition, as the dispersion state of the magnetic powder is more improved, the squareness ratio Rs1 in the longitudinal direction becomes smaller while the squareness ratio Rs2 in the perpendicular direction becomes larger. In addition, as the concentration of the solid content becomes lower, the squareness ratio Rs1 in the longitudinal direction becomes smaller while the squareness ratio Rs2 in the perpendicular direction becomes larger. Note that an adjustment method described above may be used alone or in combination of two or more.

(Saturation Magnetization Amount Ms Measured in Longitudinal Direction)

In the present technology, from a viewpoint of securing good SNR and suppressing a generation of noise, the saturation magnetization amount Ms of the magnetic recording medium in the longitudinal direction is preferably 3.0×10⁻³emu≤Ms, more preferably 3.2×10⁻³emu≤Ms, and even more preferably 3.4×10⁻³emu≤Ms.

The saturation magnetization amount Ms is determined in a manner similar to that of the measurement of the squareness ratio Rs1 in the longitudinal direction described above.

In the magnetic recording medium according to the present technology, from a viewpoint of achieving a good electromagnetic conversion characteristic, SNR may be preferably 0.3 dB or greater, more preferably 0.5 dB or greater.

(2) Method of Manufacturing Magnetic Recording Medium

Next, a method of manufacturing the magnetic recording medium 10 having the above-described configuration will be described. First, a foundation layer formation paint is prepared by kneading and dispersing the non-magnetic powder, the binder, and the like in a solvent. Next, a magnetic layer formation paint is prepared by kneading and dispersing the magnetic powder, the binder, and the like in a solvent. For preparing the magnetic layer formation paint and the foundation layer formation paint, for example, it is possible to use the following solvent, dispersing apparatus, and kneading apparatus.

Examples of the solvent to be used for the preparation of the paints described above include ketone-based solvents such as acetone, methyl ethyl ketone, methyl isobutyl ketone, or cyclohexanone, alcohol-based solvents such as methanol, ethanol, or propanol, ether-based solvents such as methyl acetate, ethyl acetate, butyl acetate, propyl acetate, ethyl lactate, or ethylene glycol acetate, ether-based solvents such as diethylene glycol dimethyl ether, 2-ethoxyethanol, tetrahydrofuran, or dioxane, aromatic hydrocarbon-based solvents such as benzene, toluene, or xylene, and halogenated hydrocarbon-based solvents such as methylene chloride, ethylene chloride, carbon tetrachloride, chloroform, or chlorobenzene. These may be used alone, or may be mixed on an as-necessary basis to be used.

Examples of the kneading apparatus to be used for the preparation of the paints described above include a continuous twin-screw kneader, a continuous twin-screw kneader that allows for a dilution in multiple stages, a kneader, a pressure kneader, and a roll kneader, although the kneading apparatus to be used for the preparation of the paints described above is not particularly limited to these apparatuses. In addition, examples of the dispersing apparatus to be used for the preparation of the paints described above include a roll mill, a ball mill, a horizontal sandmill, a vertical sandmill, a spike mill, a pin mill, a tower mill, a pearl mill (such as the “DCP Mill” manufactured by Eirich), a homodinizer, and an ultrasound disperser, although the kneading apparatus to be used for the preparation of the paints described above is not particularly limited to these apparatuses. Note that the extension of the dispersion time upon the preparation of the magnetic layer formation paint tends to increase the magnetic interaction ΔM and allows for a good electromagnetic conversion characteristic.

Next, the foundation layer formation paint is applied to one principal face of the base layer 11 and dried to form the foundation layer 12. Subsequently, the magnetic layer 13 is formed on the foundation layer 12 by application of the magnetic layer formation paint on the foundation layer 12 and drying. It should be noted that, upon drying, the magnetic powder may be subjected to a magnetic field orientation in the thickness direction of the base layer 11 by a solenoidal coil, for example. In addition, upon drying, the magnetic powder may be subjected to a magnetic field orientation in the traveling direction (the longitudinal direction) of the base layer 11, following which the magnetic powder may be subjected to the magnetic field orientation in the thickness direction of the base layer 11, by the solenoidal coil, for example. Such a magnetic field orientation process of the magnetic powder in the thickness direction of the base layer, i.e., in the perpendicular direction, tends to allow the magnetic interaction ΔM to be small (an absolute value becomes large) and allows the thermal stability to be better. In addition, such a perpendicular orientation makes it possible to improve the squareness ratio Rs. Therefore, it is possible to improve a magnitude of the perpendicular orientation of the magnetic powder. After the magnetic layer 13 is formed, the back layer 14 is formed on the other principal face of the base layer 11. Thus, the magnetic recording medium 10 is obtained.

The magnetic interaction ΔM indicates a degree of aggregation of the magnetic power particles in the magnetic layer. Factors that influence the degree of aggregation include the average particle volume of the magnetic power particle in the magnetic layer, a dispersing process, and an orientation process. In the present technology, it is possible to control the magnetic interaction ΔM of the magnetic layer within a numerical range described above by setting the average particle volume to a specified value or less and causing the magnetic power particle to be oriented perpendicularly.

The squareness ratios Rs1 and Rs2 (hereinafter, abbreviated as the squareness ratio Rs) are set to desired values by adjusting, for example, an intensity of the magnetic field to be applied to a coating film of the magnetic layer formation paint, a concentration of the solid content in the magnetic layer formation paint, and drying conditions (a drying temperature and the drying time) of a coating film of the magnetic layer formation paint. The intensity of the magnetic field to be applied to the coating film is preferably 2 times or greater and 3 times or less of the coercivity of the magnetic powder. In order to further increase the squareness ratio Rs, it is preferable to improve the dispersion state of the magnetic powder in the magnetic layer formation paint. In addition, in order to further improve squareness ratio Rs, it is also effective to magnetize the magnetic powder in advance at a stage prior to the entry of the magnetic layer formation paint into an orientation apparatus used for a magnetic field orientation of the magnetic powder. Note that a method of adjusting the squareness ratio Rs described above may be used alone or in combination of two or more.

Thereafter, the thus-obtained magnetic recording medium 10 is rewound into a core, and a hardening process is performed. Finally, the magnetic recording medium 10 is subjected to a calender process and cut to a predetermined width (e.g., ½ inch width). A desired, long and thin, elongated magnetic recording medium 10 is thus obtained by the foregoing.

(3) Recording Reproducing Apparatus

[Configuration of Recording Reproducing Apparatus]

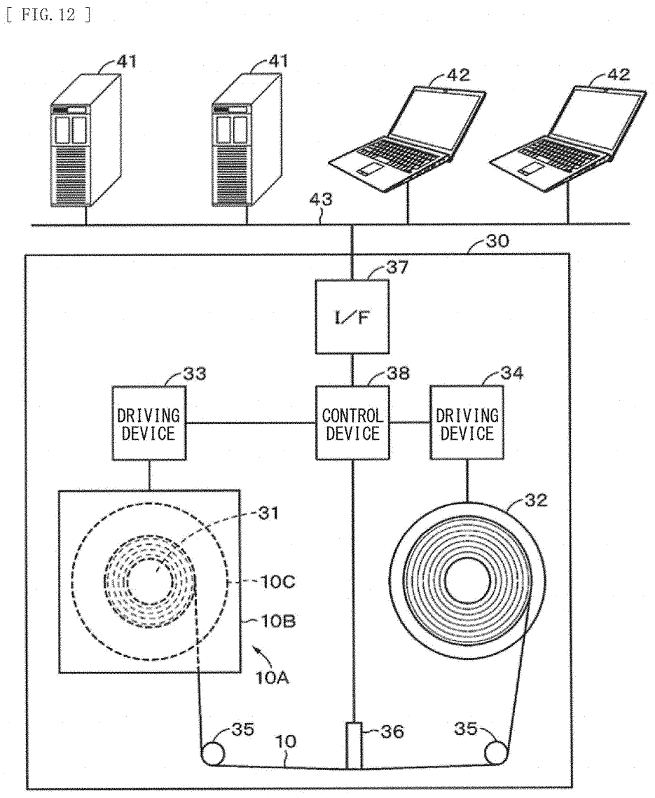

Next, referring to FIG. 12, an example of a configuration of a recording reproducing apparatus 30 that performs recording and reproducing of the magnetic recording medium 10 having the above-described configuration will be described.

The recording reproducing apparatus 30 has a configuration configured to adjust a tension to be applied to the longitudinal direction of the magnetic recording medium 10. In addition, the recording reproducing apparatus 30 has a configuration configured to load a magnetic recording cartridge 10A. Here, for easier description, a case is described where the recording reproducing apparatus 30 has a configuration configured to load one magnetic recording cartridge 10A, but the recording reproducing apparatus 30 may have a configuration configured to load a plurality of magnetic recording cartridges 10A.

The recording reproducing apparatus 30 is coupled via a network 43 to information processing apparatuses including, for example, a server 41 and a personal computer (hereinafter referred to as “PC”) 42, and is configured to record data supplied from the information processing apparatuses to the magnetic recording cartridge 10A. A shortest recording wavelength of the recording reproducing apparatus 30 may be preferably 100 nm or less, more preferably 75 nm or less, still more preferably 60 nm or less, and particularly preferably 50 nm or less.

As illustrated in FIG. 12, the recording reproducing apparatus 30 includes a spindle 31, a reel 32 on a recording reproducing apparatus side, a spindle driving device 33, a reel driving device 34, a plurality of guide rollers 35, a head unit 36, a communication interface (hereinafter, I/F) 37, and a control device 38.

The spindle 31 is configured to mount the magnetic recording cartridge 10A. The magnetic recording cartridge 10A is compliant with the LTO (Linear Tape Open) standard, and rotatably contains a single reel 10C in which the magnetic recording 10 is wound on a cartridge case 10B. In the magnetic recording medium 10, an inverted V shaped servo pattern is recorded in advance as a servo signal. The reel 32 is configured to fix a distal end of the magnetic recording medium 10 lead out from the magnetic recording cartridge 10A.

The spindle driving device 33 is a device that rotationally drives the spindle 31. The reel driving device 34 is a device that rotationally drives the reel 32. Upon performing the recording or the reproduction of data on the magnetic recording medium 10, the spindle driving device 33 and the reel driving device 34 rotationally drive the spindle 31 and the reel 32 to cause the magnetic recording medium 10 to travel. The guide roller 35 is a roller for guiding the traveling of the magnetic recording medium 10.

The head unit 36 includes a plurality of recording heads for recording a data signal in the magnetic recording medium 10, a plurality of reproducing heads for reproducing the data signal recorded in the magnetic recording medium 10, and a plurality of servo heads for reproducing the servo signal recorded in the magnetic recording medium 10. For example, it is possible to use a ring-type head as a recording head, but a type of the recording head is not limited thereto.

The communication I/F 37 is for communicating with the information processing apparatuses including, for example, the server 41 and the PC 42, and is connected to the network 43.

The control device 38 controls the recording reproducing apparatus 30 as a whole. For example, the control device 38 records the data signal supplied from the information processing apparatus in the magnetic recording medium 10 by the head unit 36, in response to a request from the information processing apparatus such as the server 41 or the PC 42. In addition, the control device 38 reproduces the data signal recorded in the magnetic recording medium 10 by the head unit 36 and supplies the reproduced data signal to the information processing apparatus, in response to a request from the information processing apparatus such as the server 41 or the PC 42.

[Operation of Recording Reproducing Apparatus]

Next, an operation of the recording reproducing apparatus 30 having the above configuration will be described.

First, the magnetic recording cartridge 10A is mounted on the recording reproducing apparatus 30, the distal end of the magnetic recording medium 10 is lead out and transferred to the reel 32 via the plurality of guide rollers 35 and the head unit 36, and the distal end of the magnetic recording medium 10 is attached to the reel 32.

Next, when an unillustrated operation section is operated, the spindle driving device 33 and the reel driving device 34 are driven under a control of the control device 38, and the spindle 31 and the reel 32 are rotated in the same direction so that the magnetic recording medium 10 travels from the reel 10C to the reel 32. Thus, while the magnetic recording medium 10 is wound on the reel 32, the recording of information to the magnetic recording medium 10 or the reproduction of information recorded in the magnetic recording medium 10 is performed by the head unit 36.

In addition, in a case where the magnetic recording medium 10 is to be rewound to the reel 10C, the spindle 31 and the reel 32 are rotationally driven in a direction opposite to the direction described above to thereby cause the magnetic recording medium 10 to travel from the reel 32 to the reel 10C. Upon the rewinding, the recording of information to the magnetic recording medium 10 or the reproduction of information recorded in the magnetic recording medium 10 is also performed by the head unit 36.

(4) Cartridge

[Configuration of Cartridge]

The present technology also provides a magnetic recording cartridge (also referred to a tape cartridge) that includes the magnetic recording medium according to the present technology. In the magnetic recording cartridge, the magnetic recording medium may be wound, for example, on a reel. The magnetic recording cartridge may include, for example, a communication section that communicates with the recording reproducing apparatus, a storage section, and a control section that stores, in the storage section, information received from the recording reproducing apparatus via the communication section, and reads the information from the storage section and transmits the information to the recording reproducing apparatus via the communication section in response to a request from the recording reproducing apparatus. The information may include adjustment information for adjusting a tension to be applied in the longitudinal direction of the magnetic recording medium. The adjustment information may include, for example, dimension data in a width direction at a plurality of positions in the longitudinal direction of the magnetic recording medium. The dimensional information in the width direction may be dimensional information at the time of manufacturing (at an initial stage after the manufacturing) of the magnetic recording medium described in [Configuration of Cartridge Memory] below, and/or dimensional information acquired upon a recording process and/or a reproduction process of the magnetic recording medium.

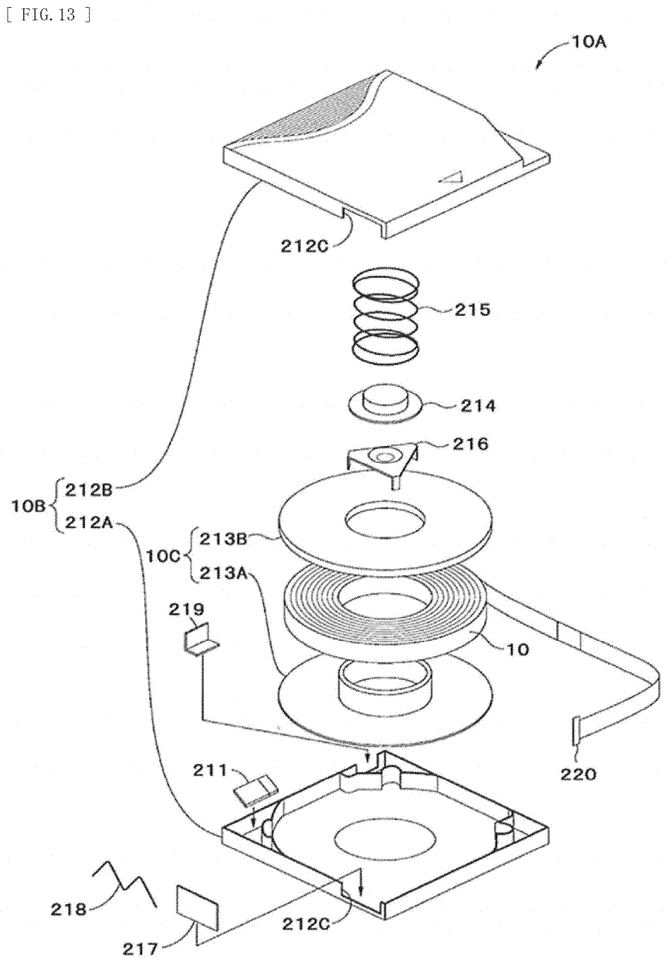

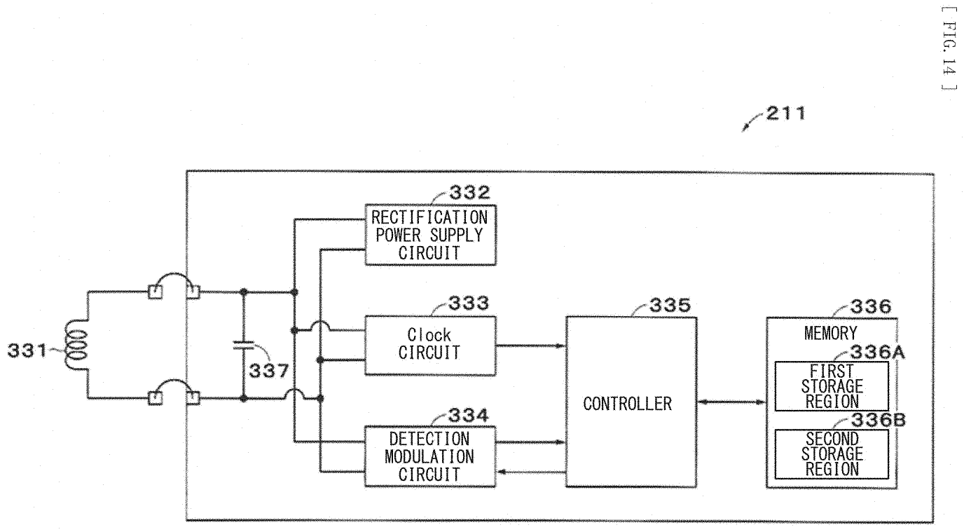

Referring to FIG. 13, an example of a configuration of the cartridge 10A including the magnetic recording medium 10 having the above-described configuration will be described.

FIG. 13 is an exploded perspective diagram illustrating an example of a configuration of the cartridge 10A. The cartridge 10A is a magnetic recording medium cartridge compliant with the LTO (Linear Tape-Open) standard, and includes, inside a cartridge case 10B configured by a lower shell 212A and an upper shell 212B, a reel 10C in which a magnetic tape (the tape-like magnetic recording medium) 10 is wound, a reel lock 214 for locking a rotation of the reel 10C and a reel spring 215, a spider 216 for releasing a locked state of the reel 10C, a slide door 217 that opens and closes a tape thread opening 212C provided on the cartridge case 10B across the lower shell 212A and the upper shell 212B, a door spring 218 that urges the slide door 217 to a closed position of the tape thread opening 212C, a write protect 219 for preventing an erroneous erasure, and a cartridge memory 211. The reel 10C has a substantially disk shape having an opening at its center, and is configured by a reel hub 213A and a flange 213B that include a hard material such as a plastic. A reader pin 220 is provided at one end of the magnetic tape 10.

The cartridge memory 211 is provided near one corner of the cartridge 10A. The cartridge memory 211 faces a reader writer (not illustrated) of the recording reproducing apparatus 30 in a state in which the cartridge 10A is loaded in the recording reproducing apparatus 30. The cartridge memory 211 communicates with the recording reproducing apparatus 30, specifically the reader writer (not illustrated), in accordance with a wireless communication standard compliant with the LTO standard.

[Configuration of Cartridge Memory]

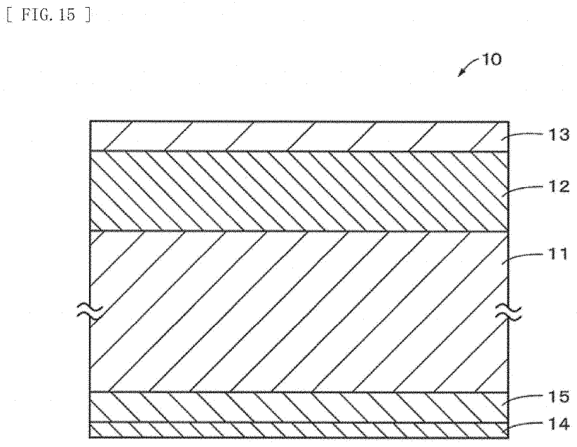

Referring to FIG. 14, an example of a configuration of the cartridge memory 211 will be described.

FIG. 14 is a block diagram illustrating an example of a configuration of the cartridge memory 211. The cartridge memory 211 includes an antenna coil (a communication section) 331 that communicates with the reader writer (not illustrated) in accordance with a prescribed communication standard, a rectification power supply circuit 332 that generates power through an electric generation and a rectification with use of an induced electromotive force from an electric wave received by the antenna coil 331, a clock circuit 333 that generates a clock by similarly using the induced electromotive force from the electric wave received by the antenna coil 331, a detection modulation circuit 334 that detects the electric wave received by the antenna coil 331 and modulates a signal transmitted by the antenna coil 331, a controller (a control section) 335 configured by a logical circuit or the like that discriminates a command and data from a digital signal extracted from the detection modulation circuit 334 and processes the command and the data, and a memory (a storage section) 336 that stores information. Further, the cartridge memory 211 includes a capacitor 337 coupled in parallel to the antenna coil 331, and the antenna coil 331 and the capacitor 337 structure a resonant circuit.

The memory 336 stores, for example, information related to the cartridge 10A. The memory 336 is a non-volatile memory (Non Volatile Memory: NVM). A storage capacity of the memory 336 is preferably about 32 KB or greater. For example, in a case where the cartridge 10A is compliant with the LTO-9 standard or the LTO-10 standard, the memory 336 has the storage capacity of about 32 KB.

The memory 336 has a first storage region 336A and a second storage region 336B. The first storage region 336A corresponds to a storage region of a cartridge memory of the LTO standard of LTO8 or its prior standards (hereinafter referred to as a “conventional cartridge memory”), and is a region for storing data compliant with the LTO standard of LTO8 or its prior standards. The information compliant with the LTO standard of LTO8 or its prior standards includes, for example, manufacturing information (e.g., the unique number of the cartridge 10A), a usage history (e.g., the tape thread count (Thread Count)), and the like.

The second storage region 336B corresponds to an extended storage region for the storage region of the conventional cartridge memory. The second storage region 336B is a region for storing additional information. Here, the additional information means information related to the cartridge 10A which is not specified by the LTO standard of LTO8 or its prior standards. Examples of the additional information include tension adjustment information, management ledger data, Index information, and thumbnail information of a moving image stored in the magnetic tape 10, although the additional information is not limited to these pieces of data. The tension adjustment information includes a distance between adjacent servo bands (a distance between servo patterns recorded in the adjacent servo bands) at the time of a data recording to the magnetic tape 10. The distance between the adjacent servo bands is an example of width-related information related to a width of the magnetic tape 10. The details of the distance between the servo bands are described later. In the following description, information to be stored in the first storage region 336A may be referred to as “first information”, and information to be stored in the second storage region 336B may be referred to as “second information”.

The memory 336 may have a plurality of banks. In this case, the first storage region 336A may be configured by a part of the plurality of banks, and the second storage region 336B may be configured by the remaining banks. Specifically, for example, in a case where the cartridge 10A is compliant with the LTO-9 standard or the LTO-10 standard, the memory 336 may have two banks having the storage capacity of about 16 KB, the first storage region 336A may be configured by one of the two banks, and the second storage region 336B may be configured by the other bank.

The antenna coil 331 induces an induced voltage by an electromagnetic induction. The controller 335 communicates with the recording reproducing apparatus 30 in accordance with a prescribed communication standard via the antenna coil 331. Specifically, the controller 335 performs, for example, a mutual authentication, sending and receiving of a command, an exchange of data, and the like.

The controller 335 stores, in the memory 336, information received from the recording reproducing apparatus 30 via the antenna coil 331. The controller 335 reads information from the memory 336 and transmits the information to the recording reproducing apparatus 30 via the antenna coil 331, in response to a request from the recording reproducing apparatus 30.

(5) Modification Example of Cartridge

[Configuration of Cartridge]

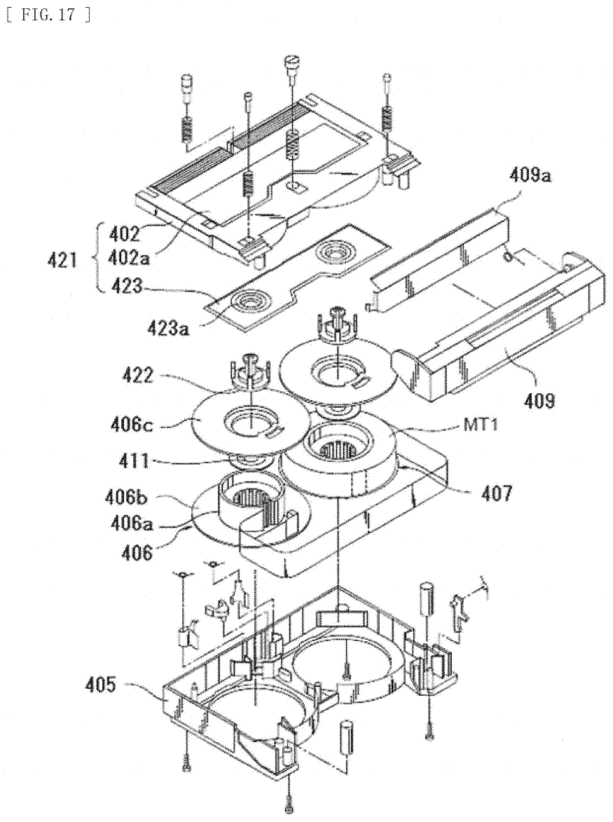

In an embodiment of the magnetic recording cartridge described above, described is a case where the magnetic tape cartridge is a cartridge of a one reel type, but the magnetic recording cartridge according to the present technology may be a cartridge of a two-reel type. That is, the magnetic recording cartridge according to the present technology may have one or more (e.g., two) reels on which the magnetic tape is wound. Hereinafter, referring to FIG. 17, described is an example of the magnetic recording cartridge according to the present technology having two reels.

FIG. 17 is an exploded perspective diagram illustrating an example of a configuration of a cartridge 421 of the two-reel type. The cartridge 421 includes an upper half 402 that includes a synthetic resin, a transparent window member 423 fitted and fixed to a window section 402a opened at an upper surface of the upper half 402, a reel holder 422 fixed to an inner side of the upper half 402 and prevents reels 406 and 407 from floating, a lower half 405 corresponding to the upper half 402, the reels 406 and 407 stored in a space formed by combining the upper half 402 and the lower half 405, a magnetic tape MT1 wound on the reels 406 and 407, a front lid 409 that closes a front side opening formed by a combining the upper half 402 and the lower half 405, and a back lid 409A that protects the magnetic tape MT1 exposed at the front side opening.

The reel 406 includes a lower flange 406b having, in its center, a cylindrical hub section 406a around which the magnetic tape MT1 is wound, an upper flange 406c having substantially the same size as the lower flange 406b, and a reel plate 411 interposed between the hub section 406a and the upper flange 406c. The reel 407 has a configuration similar to that of the reel 406.

The window member 423 has, at respective positions corresponding to the reels 406 and 407, attachment holes 423a for attaching a reel holder 422 that serves as reel holding means that prevents the reels from floating. The magnetic tape MT1 is similar to the magnetic tape T in the first embodiment.

(6) Effect

In the magnetic recording medium 10, the average particle volume of the magnetic powder included in the magnetic layer 13 is 2300 nm³ or less, and the magnetic interaction ΔM of the magnetic layer 13 is −0.362≤ΔM≤−0.22. Thus, the magnetic recording medium 10 has a good thermal stability and a good electromagnetic conversion characteristic.

(7) Modification Examples

(Modification Example 1)

The magnetic recording medium 10 may further include a barrier layer 15 provided on at least one of surfaces of the base layer 11 as illustrated in FIG. 15. The barrier layer 15 is a layer for suppressing a dimensional change attributed to an environment of the base layer 11. For example, there is hygroscopicity of the base layer 11 as an example of a cause of the dimensional change. However, it is possible to reduce a speed of entry of a moisture into the base layer 11 by providing the barrier layer 15. The barrier layer 15 may include, for example, a metal or a metal oxide. As the metal, for example, it is possible to use at least one of Al, Cu, Co, Mg, Si, Ti, V, Cr, Mn, Fe, Ni, Zn, Ga, Ge, Y, Zr, Mo, Ru, Pd, Ag, Ba, Pt, Au, or Ta. As the metal oxide, for example, it is possible to use a metal oxide including one or two or more of the metals described above. More specifically, for example, it is possible to use at least one of Al₂O₃, CuO, CoO, SiO₂, Cr₂O₃, TiO₂, Ta₂O₅, or ZrO₂. Further, the barrier layer 15 may include diamond-like carbon (Diamond-Like Carbon: DLC), diamond, or the like.

An average thickness of the barrier layer 15 may be preferably 20 nm or greater and 1000 nm or less, more preferably 50 nm or greater and 1000 nm or less. The average thickness of the barrier layer 15 is determined in a manner similar to the average thickness of the magnetic layer 13. However, a magnification of a TEM image is adjusted on an as-necessary basis in accordance with the thickness of the barrier layer 15.

(Modification Example 2)

The magnetic recording medium 10 may be incorporated into a library apparatus. That is, the present technology also provides a library apparatus that includes at least one magnetic recording medium 10. The library apparatus has a configuration configured to adjust a tension to be applied in the longitudinal direction of the magnetic recording medium 10, and may include a plurality of the recording reproducing apparatuses 30 described above.

### 3. EXAMPLES

Hereinafter, the present technology will be described specifically by referring to Examples, but the present technology is not limited to these Examples.

In the present Examples, the average thickness of a base film (the base layer), the average thickness of the magnetic layer, the average thickness of the foundation layer, the average thickness of the back layer, the average thickness of the magnetic tape (the magnetic recording medium), the average particle volume of the magnetic powder, the magnetic interaction ΔM, the squareness ratio Rs2 in the perpendicular direction, the squareness ratio Rs1 in the longitudinal direction, the saturation magnetization amount Ms, and the thermal stability KᵤV_{act}/k_{B}T (a measurement temperature was 25° C.) were determined by the measuring methods described in the embodiments described above.

The SNR was measured as follows.

### (SNR in 25° C. Environment)

The SNR (an electromagnetic conversion characteristic) of a magnetic tape in 25° C. environment was measured using a ½-inch tape traveling apparatus (MTS Transport manufactured by Mountain Engineering II, Inc.) attached with a recording/reproducing head and a recording/reproducing amplifier. A ring head having a gap length of 0.2 μm was used for a recording head, and a GMR head having a shield-to-shield distance of 0.1 μm was used for a reproducing head. A relative speed was 6 m/s, and a recording clock frequency was 160 MHz.

Further, the SNR was calculated on the basis of the method described in the following literature (a measurement method using a spectrum analyzer). Results are illustrated in Table 1 below with the SNR of Example 4 being a relative value of 1.0 dB. Y. Okazaki: “An Error Rate Emulation System.”, IEEE Trans. Man., 31, pp.3093-3095 (1995)

### Example 1

(Preparation Step of Magnetic Layer Formation Paint)

The magnetic layer formation paint was prepared as follows. First, a first composition having the following formulation was kneaded in an extruder. Next, the kneaded first composition and a second composition having the following formulation were added to a stirring tank having a disper to perform premixing. Subsequently, a sand mill mixing was further performed, and a filter process was performed to prepare the magnetic layer formation paint.

(First Composition)
A magnetic powder (a hexagonal ferrite having a M-type structure, composition: Ba-Ferrite, an average particle volume: 1600 nm³): 100 parts by mass
A vinyl chloride-based resin (30% by mass of a cyclohexanone solution): 60 parts by mass
(A polymerization degree: 300, Mn=10000, contains OSO₃K=0.07 mmol/g and secondary OH=0.3 mmol/g as polar groups)
An aluminum oxide powder: 5 parts by mass
(α-Al₂O₃, an average particle size of 0.2 pin)
Carbon black: 2 parts by mass
(manufactured by Tokai Carbon Co., Ltd., trade name: SEAST TA)

(Second Composition)
A vinyl chloride-based resin: 1.1 parts by mass
(a resin solution: a resin content of 30% by mass, cyclohexanone of 70% by mass)
n-butyl stearate: 2 parts by mass
Methyl ethyl ketone: 121.3 parts by mass
Toluene: 121.3 parts by mass
Cyclohexanone: 60.7 parts by mass

Lastly, to the magnetic layer formation paint prepared as described above, polyisocyanate (trade name: Coronate L, manufactured by Nippon Polyurethane Co., Ltd.): 2 parts by mass and myristic acid: 2 parts by mass were added as a hardener.

(Preparation Step of Foundation Layer Formation Paint)

The foundation layer formation paint was prepared as follows. First, a third composition having the following formulation was kneaded in an extruder. Next, the kneaded third composition and a fourth composition having the following formulation were added to a stirring tank having a disper to perform premixing. Subsequently, a sand mill mixing was further performed, and a filter process was performed to prepare the foundation layer formation paint.

(Third Composition)
A needle-shaped iron oxide powder: 100 parts by mass
(α-Fe₂O₃, an average major axis length of 0.15 μm)
A vinyl chloride resin: 55.6 parts by mass
(A resin solution: a resin content of 30% by mass, cyclohexanone of 70% by mass)
Carbon black: 10 parts by mass
(An average particle size of 20 nm)

(Fourth Composition)
A polyurethane-based resin UR8200 (manufactured by Toyobo Co., Ltd.): 18.5 parts by mass
n-butyl stearate: 2 parts by mass
Methyl ethyl ketone: 108.2 parts by mass
Toluene: 108.2 parts by mass
Cyclohexanone: 18.5 parts by mass

Lastly, to the foundation layer formation paint prepared as described above, polyisocyanate (trade name: Coronate L, manufactured by Tosoh Corporation): 2 parts by mass and myristic acid: 2 parts by mass were added as a hardener.

(Preparation Step of Back Layer Formation Paint)

The back layer formation paint was prepared as follows. The following raw materials were mixed in a stirring tank having a disper and a filter process was performed to prepare the back layer formation paint.
Carbon black (manufactured by Asahi Co. Ltd., trade name: #80): 100 parts by mass
Polyester Polyurethane: 100 parts by mass
(manufactured by Nippon Polyurethane Co., Ltd., trade name: N-2304)
Methyl ethyl ketone: 500 parts by mass
Toluene: 400 parts by mass
Cyclohexanone: 100 parts by mass
Polyisocyanate (trade name: Coronate L, manufactured by Tosoh Corporation): 10 parts by mass

(Film Formation Process)

The paints fabricated as described above were used to fabricate a magnetic tape as described below.

First, as a support body serving as the base layer of the magnetic tape, a PEN film (a base film) having an elongated shape and an average thickness of 4.0 μm was prepared. Next, the foundation layer formation paint was applied on one principal face of the PEN film and dried to form the foundation layer on the one principal face of the PEN film so that an average thickness of 1.1 μm upon a final product is obtained. Next, the magnetic layer formation paint was applied on the foundation layer and dried to form the magnetic layer on the foundation layer so that an average thickness of 80 nm upon the final product is obtained.

Subsequently, the back layer formation paint was applied onto the other principal face of the PEN film on which the foundation layer and the magnetic layer were formed, and dried to form the back layer so that an average thickness of 0.4 μm upon the final product is obtained. Further, the PEN film on which the foundation layer, the magnetic layer, and the back layer were formed was subjected to a hardening process. Thereafter, a calender process was performed to smooth a surface of the magnetic layer.

(Cutting Step)

The magnetic tape obtained as described above was cut to a ½ inch (12.65 mm) width. This obtained a magnetic tape having an elongated shape and an average thickness of 5.6 μm. The thus-obtained magnetic tape had the average thickness of the base film (the base layer), the average thickness of the magnetic layer, the average thickness of the foundation layer, the average thickness of the back layer, the average thickness of the magnetic tape (the magnetic recording medium), the average particle volume of the magnetic powder, the magnetic interaction ΔM, the squareness ratio Rs2 in the perpendicular direction, the squareness ratio Rs1 in the longitudinal direction, the saturation magnetization amount Ms, and the thermal stability KᵤV_{act}/k_{B}T (the measurement temperature was 25° C.) represented in Table 1.

### Example 2

Example 2 differed from Example 1 in that the average particle volume of the magnetic powder was further micronized to 1450 nm³, and the dispersing time upon the preparation of the magnetic layer formation paint was extended, but other conditions and methods were caused to be the same as those of Example 1 to obtain a magnetic tape. A configuration and physical properties of the thus-obtained magnetic tape had values as represented in Table 1.

### Example 3

Example 3 differed from Example 1 in that the average particle volume of the magnetic powder was further micronized to 1450 nm³, but other conditions and methods were caused to be the same as those of Example 1 to obtain a magnetic tape. A configuration and physical properties of the thus-obtained magnetic tape had values as represented in Table 1.

### Example 4

Example 4 differed from Example 1 in that the dispersing time upon the preparation of the magnetic layer formation paint was shortened, but other conditions and methods were caused to be the same as those of Example 1 to obtain a magnetic tape. A configuration and physical properties of the thus-obtained magnetic tape had values as represented in Table 1.

### Example 5

The magnetic powder was subjected to a magnetic field orientation in a thickness direction of the PEN film by means of a solenoidal coil upon drying of the magnetic layer formation paint. Specifically, Example 5 differed from Example 1 in that the magnetic powder was once subjected to a magnetic field orientation in a traveling direction (a longitudinal direction) of the PEN film by the solenoidal coil, following which the magnetic powder was subjected to the magnetic field orientation (the perpendicular orientation) in the thickness direction of the PEN film by the solenoidal coil, but other conditions and methods were caused to be the same as those of Example 1 to obtain a magnetic tape. A configuration and physical properties of the thus-obtained magnetic tape had values as represented in Table 1.

### Example 6

Example 6 differed from Example 1 in that the average thickness of the magnetic layer was caused to be 90 nm upon the final product, but other conditions and methods were caused to be the same as those of Example 1 to obtain a magnetic tape. A configuration and physical properties of the thus-obtained magnetic tape had values as represented in Table 1.

### Example 7

Example 7 differed from Example 1 in that the magnetic powder was subjected to the magnetic field orientation in the thickness direction of the PEN film upon drying of the magnetic layer formation paint and the dispersing time upon the preparation of the magnetic layer formation paint was shortened, but other conditions and methods were caused to be the same as those of Example 1 to obtain a magnetic tape. A configuration and physical properties of the thus-obtained magnetic tape had values as represented in Table 1.

### Example 8

Example 8 differed from Example 1 in that the average particle volume of the magnetic powder was increased to 2300 nm³, the magnetic powder was subjected to the magnetic field orientation in the thickness direction of the PEN film upon drying of the magnetic layer formation paint, the dispersing time upon the preparation of the magnetic layer formation paint was extended, and the dispersion property was improved, but other conditions and methods were caused to be the same as those of Example 1 to obtain a magnetic tape. A configuration and physical properties of the thus-obtained magnetic tape had values as represented in Table 1.

### Example 9

Example 9 differed from Example 1 in that the average particle volume of the magnetic powder was increased to 2300 nm³, the magnetic powder was subjected to the magnetic field orientation in the thickness direction of the PEN film upon drying of the magnetic layer formation paint, and the dispersion property was improved, but other conditions and methods were caused to be the same as those of Example 1 to obtain a magnetic tape. A configuration and physical properties of the thus-obtained magnetic tape had values as represented in Table 1.

### Comparative Example 1

Comparative Example 1 differed from Example 1 in that the average particle volume of the magnetic powder was increased to 2500 nm³, but other conditions and methods were caused to be the same as those of Example 1 to obtain a magnetic tape. A configuration and physical properties of the thus-obtained magnetic tape had values as represented in Table 1.

### Comparative Example 2

Comparative Example 2 differed from Example 1 in that the average particle volume of the magnetic powder was further micronized to 1260 nm³, and the average thickness of the magnetic layer was caused to be 60 nm upon the final product, but other conditions and methods were caused to be the same as those of Example 1 to obtain a magnetic tape. A configuration and physical properties of the thus-obtained magnetic tape had values as represented in Table 1.

### Comparative Example 3

Comparative Example 3 differed from Example 1 in that the average particle volume of the magnetic powder was further micronized to 1260 nm³, but other conditions and methods were caused to be the same as those of Example 1 to obtain a magnetic tape. A configuration and physical properties of the thus-obtained magnetic tape had values as represented in Table 1.

TABLE 1

| | Exam- | Exam- | Exam- | Exam- | Exam- | Exam- | Exam- |
|---|---|---|---|---|---|---|---|
| | ple 1 | ple 2 | ple 3 | ple 4 | ple 5 | ple 6 | ple 7 |
| Entire thickness | 5.6 | 5.6 | 5.6 | 5.6 | 5.6 | 5.6 | 5.6 |
| of magnetic | | | | | | | |
| tape (μm) | | | | | | | |
| Thickness of | 4.0 | 4.0 | 4.0 | 4.0 | 4.0 | 4.0 | 4.0 |
| base layer (μm) | | | | | | | |
| Material of base | PEN | PEN | PEN | PEN | PEN | PEN | PEN |
| layer | | | | | | | |
| Thickness of | 80 | 80 | 80 | 80 | 80 | 90 | 80 |
| magnetic layer | | | | | | | |
| (nm) | | | | | | | |
| Thickness of | 1.1 | 1.1 | 1.1 | 1.1 | 1.1 | 1.1 | 1.1 |
| foundation | | | | | | | |
| layer (μm) | | | | | | | |
| Thickness of | 0.4 | 0.4 | 0.4 | 0.4 | 0.4 | 0.4 | 0.4 |
| back layer (μm) | | | | | | | |
| Magnetic | 1600 | 1450 | 1450 | 1600 | 1600 | 1600 | 1600 |
| powder volume | | | | | | | |
| (nm³) | | | | | | | |
| Perpendicular | NO | NO | NO | NO | YES | NO | YES |
| orientation | | | | | | | |
| Saturation | 2.88E−03 | 3.57E−03 | 3.42E−03 | 3.34E−03 | 2.95E−03 | 3.42E−03 | 3.21E−03 |
| magnetization | | | | | | | |
| amount Ms | | | | | | | |
| (longitudinal | | | | | | | |
| direction) (emu) | | | | | | | |
| Perpendicular | 55 | 54 | 55 | 54 | 65 | 55 | 62 |
| direction | | | | | | | |
| squareness ratio | | | | | | | |
| Rs2 (%) | | | | | | | |
| Longitudinal | 40 | 39 | 38 | 42 | 33 | 41 | 34 |
| direction | | | | | | | |
| squareness ratio | | | | | | | |
| Rs1 (%) | | | | | | | |
| Thermal | 63 | 65 | 65 | 65 | 77 | 64 | 81 |
| stability | | | | | | | |
| KuV/kbT (—) | | | | | | | |
| Electromagnetic | 0.8 | 0.6 | 0.9 | 1.0 | 1.2 | 1.05 | 1.02 |
| conversion | | | | | | | |
| characteristic | | | | | | | |
| SNR (dB) | | | | | | | |
| ΔM (—) | −0.22 | −0.224 | −0.225 | −0.225 | −0.244 | −0.261 | −0.283 |

| | | | Compar- | Compar- | Compar- |
|---|---|---|---|---|---|
| | | | ative | ative | ative |
| | Exam- | Exam- | Example | Example | Example |
| | ple 8 | ple 9 | 1 | 2 | 3 |
| Entire thickness | 5.6 | 5.6 | 5.6 | 5.6 | 5.6 |
| of magnetic | | | | | |
| tape (μm) | | | | | |
| Thickness of | 4.0 | 4.0 | 4.0 | 4.0 | 4.0 |
| base layer (μm) | | | | | |
| Material of base | PEN | PEN | PEN | PEN | PEN |
| layer | | | | | |
| Thickness of | 80 | 80 | 80 | 60 | 80 |
| magnetic layer | | | | | |
| (nm) | | | | | |
| Thickness of | 1.1 | 1.1 | 1.1 | 1.1 | 1.1 |
| foundation | | | | | |
| layer (μm) | | | | | |
| Thickness of | 0.4 | 0.4 | 0.4 | 0.4 | 0.4 |
| back layer (μm) | | | | | |
| Magnetic | 2300 | 2300 | 2500 | 1260 | 1260 |
| powder volume | | | | | |
| (nm³) | | | | | |
| Perpendicular | YES | YES | NO | NO | NO |
| orientation | | | | | |
| Saturation | 3.07E−03 | 3.28E−03 | 2.92E−03 | 2.87E−03 | 3.24E−03 |
| magnetization | | | | | |
| amount Ms | | | | | |
| (longitudinal | | | | | |
| direction) (emu) | | | | | |
| Perpendicular | 63 | 68 | 57 | 56 | 55 |
| direction | | | | | |
| squareness ratio | | | | | |
| Rs2 (%) | | | | | |
| Longitudinal | 32 | 36 | 43 | 38 | 37 |
| direction | | | | | |
| squareness ratio | | | | | |
| Rs1 (%) | | | | | |
| Thermal | 84 | 89 | 73 | 62 | 62 |
| stability | | | | | |
| KuV/kbT (—) | | | | | |
| Electromagnetic | 0.4 | 0.3 | 0.2 | 0.7 | 0.69 |
| conversion | | | | | |
| characteristic | | | | | |
| SNR (dB) | | | | | |
| ΔM (—) | −0.299 | −0.362 | −0.217 | −0.197 | −0.179 |

The following is appreciated from Table 1.

Each of the magnetic tapes according to Examples 1 to 9 had the average particle volume of the magnetic powder of 2300 nm³ or less, and the magnetic interaction ΔM satisfied the relationship of −0.362≤ΔM≤−0.22. Accordingly, the magnetic tapes according to Examples 1 to 9 each showed the good thermal stability KᵤV_{act}/k_{B}T of 63 or greater. Further, the magnetic tapes according to Examples 1 to 9 each showed the SNR of 0.3 dB or greater and the electromagnetic conversion characteristic was good. It can be appreciated from these results that the magnetic recording medium according to the present technology is good for both the thermal stability and the electromagnetic conversion characteristic.

Examples 1 to 7 had the better electromagnetic conversion characteristic than Example 8 and Example 9. In Examples 1 to 7, the average particle volume of the magnetic powder was smaller than 2000 nm³, whereas Examples 8 and 9 both had the large average particle volume of the magnetic powder of 2300 nm³. It can be appreciated therefrom that the electromagnetic conversion characteristic improves by reducing the average particle volume of the magnetic powder.

It can be appreciated that Comparative Examples 1 to 3 in which the average particle volume of the magnetic powder was 2300 nm³ or less and the magnetic interaction ΔM did not satisfy the relationship of −0.362≤ΔM≤−0.22 are inferior in either the thermal stability or the electromagnetic conversion characteristic.

While embodiments and Examples of the present technology have been specifically described above, the present technology is not limited to the above-described embodiments and Examples, and various modifications based on the technical idea of the present technology can be made.

For example, configurations, methods, process steps, shapes, materials, numerical values, and the like described in the above embodiments and Examples are merely examples, and other configurations, methods, process steps, shapes, materials, numerical values, and the like may be used on an as-necessary basis. In addition, a chemical formula of a compound or the like is typical, and is not limited to the described equivalent number and the like as long as the generic name of the same compound is used.

In addition, it is possible to combine with each other configurations, methods, process steps, shapes, materials, numerical values, and the like of the above-described embodiments and Examples without departing from the spirit of the present technology.

In addition, in the present specification, a numerical range denoted by “to” indicates a range including numerical values described before and after “to” as a minimum value and a maximum value, respectively. In numerical ranges described stepwise in the present specification, an upper limit value or a lower limit value of a numerical range of a certain level may be replaced by an upper limit value or a lower limit value of a numerical range of another level. Unless otherwise specified, it is possible to use one of the materials exemplified in this specification alone, or it is possible to use two or more of the materials exemplified in this specification in combination.

It should be appreciated that the present technology may have the following configurations.

[1]

A magnetic recording medium, including a layer structure including:

a base layer; and

a magnetic layer provided on the base layer and including a magnetic powder, in which

an average thickness t_{T} of the magnetic recording medium is 5.4 μm or less,

an average particle volume of the magnetic powder is 2300 nm³ or less, and

a magnetic interaction ΔM calculated by the following expression (1) of the magnetic layer is −0.362≤ΔM≤−0.22,

ΔM={Id(H)+2Ir(H)−Ir(≤)}/Ir(≤) (1)

[in which, in the expression (1), Id(H) is a remanent magnetization measured by a direct-current demagnetization, Ir(H) is a remanent magnetization measured by an alternating-current demagnetization, and Ir(∞) is a remanent magnetization measured by an applied magnetic field of 6 kOe].

[2]

The magnetic recording medium according to [1], in which the magnetic powder is subjected to a perpendicular orientation.

[3]

The magnetic recording medium according to [1] or [2], in which the magnetic interaction ΔM calculated by the expression (1) of the magnetic layer is −0.35≤ΔM.

[4]

The magnetic recording medium according to any one of [1] to [3], in which the magnetic interaction ΔM calculated by the expression (1) of the magnetic layer is −0.3≤ΔM.

[5]

The magnetic recording medium according to any one of [1] to [4], in which the average particle volume of the magnetic powder is 1600 nm³ or less.

[6]

The magnetic recording medium according to any one of [1] to [5], in which the average thickness t_{T} of the magnetic recording medium is 5.3 μm or less.

[7]

The magnetic recording medium according to any one of [1] to [5], in which the average thickness t_{T} of the magnetic recording medium is 5.2 μm or less.

[8]

The magnetic recording medium according to any one of [1] to [7], in which an average thickness t_{B} of the base layer is 4.8 μm or less.

[9]

The magnetic recording medium according to any one of [1] to [7], in which an average thickness t_{B} of the base layer is 4.4 μm or less.

The magnetic recording medium according to any one of [1] to [9], in which the base layer includes PET (polyethylene terephthalate) or PEN (polyethylene naphthalate).

The magnetic recording medium according to any one of [1] to [10], in which a saturation magnetization amount Ms in a longitudinal direction of the recording medium satisfies the following relation:

3.0×10⁻³emu≤Ms

The magnetic recording medium according to any one of [1] to [11], in which an average thickness of the magnetic layer is 80 nm or less.

The magnetic recording medium according to any one of [1] to [11], in which an average thickness of the magnetic layer is 70 nm or less.

The magnetic recording medium according to any one of [1] to [11], in which an average thickness of the magnetic layer is 60 nm or less.

The magnetic recording medium according to any one of [1] to [14], in which a squareness ratio in a perpendicular direction of the magnetic recording medium is 65% or greater.

The magnetic recording medium according to any one of [1] to [14], in which a squareness ratio in a perpendicular direction of the magnetic recording medium is 67% or greater.

The magnetic recording medium according to any one of [1] to [14], in which a squareness ratio in a perpendicular direction of the magnetic recording medium is 70% or greater.

The magnetic recording medium according to any one of [1] to [17], in which the layer structure includes the magnetic layer, a foundation layer, and the base layer in this order.

The magnetic recording medium according to [18], in which a ratio of (an average thickness of the magnetic layer+an average thickness of the foundation layer)/(an average thickness of the base layer) is 0.16 or greater.

The magnetic recording medium according to any one of [1] to [19], in which the layer structure includes the magnetic layer, a foundation layer, the base layer, and a back layer in this order.

The magnetic recording medium according to [20], in which a ratio of (an average thickness of the magnetic layer+an average thickness of the foundation layer+an average thickness of the back layer)/(the average thickness of the magnetic recording medium) is 0.19 or greater.

The magnetic recording medium according to any one of [1] to [21], in which a thermal stability KᵤV_{act}/k_{B}T of the magnetic recording medium is 63 or greater.

The magnetic recording medium according to any one of [1] to [22], in which SNR of the magnetic recording medium is 0.3 dB or greater.

The magnetic recording medium according to any one of [1] to [23], in which the magnetic powder includes a hexagonal ferrite.

A tape cartridge including:

the magnetic recording medium according to any one of [1] to [24] that has a tape shape;

a communication section that communicates with a recording reproducing apparatus;

a storage section; and

a control section that stores, in the storage section, information received from the recording reproducing apparatus via the communication section, and reads the information from the storage section and transmits the information to the recording reproducing apparatus via the communication section in response to a request from the recording reproducing apparatus, in which

the information includes adjustment information for adjusting a tension to be applied in a longitudinal direction of the magnetic recording medium.

[26]

The magnetic recording medium according to any one of [1] to [24], in which the average particle volume of the magnetic powder is 1500 nm³ or less.

[27]

The magnetic recording medium according to any one of [1] to [24], in which the average particle volume of the magnetic powder is 1400 nm³ or less.

[28]

The magnetic recording medium according to any one of [1] to [24], in which an average thickness t_{B} of the base layer is 4.2 μm or less.

[29]

The magnetic recording medium according to any one of [1] to [24], in which an average thickness of the magnetic layer is 50 nm or less.

[30]

A cartridge, including the magnetic recording medium according to any one of [1] to [24].

[31]

The cartridge according to [30], further including a storage section having a region that writes adjustment information for adjusting a tension to be applied in a longitudinal direction of the magnetic recording medium.

The magnetic recording medium according to any one of [1] to [24], in which the magnetic interaction ΔM calculated by the expression (1) of the magnetic layer is ΔM≤−0.27.

### DESCRIPTION OF NUMERALS

10 Magnetic recording medium
11 Base layer (base layer)
12 Foundation layer
13 Magnetic layer
14 Back layer

1. A magnetic recording medium, comprising a layer structure including:
a base layer; and
a magnetic layer provided on the base layer and including a magnetic powder, wherein
an average thickness t_{T} of the magnetic recording medium is 5.4 μm or less,
an average particle volume of the magnetic powder is 2300 nm³ or less, and
a magnetic interaction ΔM calculated by the following expression (1) of the magnetic layer is −0.362≤ΔM≤−0.22,
ΔM={Id(H)+2Ir(H)−Ir(∞)}/Ir(∞) (1)
[where, in the expression (1), Id(H) is a remanent magnetization measured by a direct-current demagnetization, Ir(H) is a remanent magnetization measured by an alternating-current demagnetization, and Ir(∞) is a remanent magnetization measured by an applied magnetic field of 6 kOe].

2. The magnetic recording medium according to claim 1, wherein the magnetic powder is subjected to a perpendicular orientation.

3. The magnetic recording medium according to claim 1, wherein the magnetic interaction ΔM calculated by the expression (1) of the magnetic layer is −0.35≤ΔM.

4. The magnetic recording medium according to claim 1, wherein the magnetic interaction ΔM calculated by the expression (1) of the magnetic layer is −0.3≤ΔM.

5. The magnetic recording medium according to claim 1, wherein the average particle volume of the magnetic powder is 1600 nm³ or less.

6. The magnetic recording medium according to claim 1, wherein the average thickness t_{T} of the magnetic recording medium is 5.3 μm or less.

7. The magnetic recording medium according to claim 1, wherein the average thickness t_{T} of the magnetic recording medium is 5.2 μm or less.

8. The magnetic recording medium according to claim 1, wherein an average thickness t_{B} of the base layer is 4.8 μm or less.

9. The magnetic recording medium according to claim 1, wherein an average thickness t_{B} of the base layer is 4.4 μm or less.

10. The magnetic recording medium according to claim 1, wherein the base layer includes PET (polyethylene terephthalate) or PEN (polyethylene naphthalate).

11. The magnetic recording medium according to claim 1, wherein a saturation magnetization amount Ms in a longitudinal direction of the recording medium satisfies the following relation:
3.0×10⁻³emu≤Ms

12. The magnetic recording medium according to claim 1, wherein an average thickness of the magnetic layer is 80 nm or less.

13. The magnetic recording medium according to claim 1, wherein an average thickness of the magnetic layer is 70 nm or less.

14. The magnetic recording medium according to claim 1, wherein an average thickness of the magnetic layer is 60 nm or less.

15. The magnetic recording medium according to claim 1, wherein a squareness ratio in a perpendicular direction of the magnetic recording medium is 65% or greater.

16. The magnetic recording medium according to claim 1, wherein a squareness ratio in a perpendicular direction of the magnetic recording medium is 67% or greater.

17. The magnetic recording medium according to claim 1, wherein a squareness ratio in a perpendicular direction of the magnetic recording medium is 70% or greater.

18. The magnetic recording medium according to claim 1, wherein the layer structure includes the magnetic layer, a foundation layer, and the base layer in this order.

19. The magnetic recording medium according to claim 18, wherein a ratio of (an average thickness of the magnetic layer+an average thickness of the foundation layer) / (an average thickness of the base layer) is 0.16 or greater.

20. The magnetic recording medium according to claim 1, wherein the layer structure includes the magnetic layer, a foundation layer, the base layer, and a back layer in this order.

21. The magnetic recording medium according to claim 20, wherein a ratio of (an average thickness of the magnetic layer+an average thickness of the foundation layer+an average thickness of the back layer)/(the average thickness of the magnetic recording medium) is 0.19 or greater.

22. The magnetic recording medium according to claim 1, wherein a thermal stability KᵤV_{act}/k_{B}T of the magnetic recording medium is 63 or greater.

23. The magnetic recording medium according to claim 1, wherein SNR of the magnetic recording medium is 0.3 dB or greater.

24. The magnetic recording medium according to claim 1, wherein the magnetic powder comprises a hexagonal ferrite.

25. A tape cartridge comprising:
the magnetic recording medium according to claim 1 that has a tape shape;
a communication section that communicates with a recording reproducing apparatus;
a storage section; and
a control section that stores, in the storage section, information received from the recording reproducing apparatus via the communication section, and reads the information from the storage section and transmits the information to the recording reproducing apparatus via the communication section in response to a request from the recording reproducing apparatus, wherein
the information includes adjustment information for adjusting a tension to be applied in a longitudinal direction of the magnetic recording medium.

26. The magnetic recording medium according to claim 1, wherein the average particle volume of the magnetic powder is 1500 nm³ or less.

27. The magnetic recording medium according to claim 1, wherein the average particle volume of the magnetic powder is 1400 nm³ or less.

28. The magnetic recording medium according to claim 1, wherein an average thickness t_{B} of the base layer is 4.2 μm or less.

29. The magnetic recording medium according to claim 1, wherein an average thickness of the magnetic layer is 50 nm or less.

30. A cartridge, comprising the magnetic recording medium according to claim 1.

31. The cartridge according to claim 30, further comprising a storage section having a region that writes adjustment information for adjusting a tension to be applied in a longitudinal direction of the magnetic recording medium.

32. The magnetic recording medium according to claim 1, wherein the magnetic interaction ΔM calculated by the expression (1) of the magnetic layer is ΔM≤−0.27.
